(19) United States
(12) Patent Application Publication
(10) Pub. No.: US 2007/0074113 A1
(43) Pub. Date: Mar. 29, 2007

(54) Multi function device

(75) Inventor: Takahiro Ikeno, Seto-shi (JP)

Correspondence Address: MCDERMOTT WILL & EMERY LLP, 600 13TH STREET, N.W., WASHINGTON, DC, 20005-3096, US

(73) Assignee: BROTHER KOGYO KABUSHIKI KAISHA

(21) Appl. No.: 11/492,914

(22) Filed: Jul. 26, 2006

(30) Foreign Application Priority Data
Jul. 26, 2005 (JP) 2005-216566

(51) Int. Cl. G06F 3/00; G06F 17/00; G06F 9/00

(52) U.S. Cl. 715/700

(57) ABSTRACT

A multi function device having a plurality of functions, which comprises: an operation key that inputs an instruction for the function; a display unit that displays information on the function; and a control unit that outputs a predetermined code signal based on an input of the operation key and controls display contents of the display unit. The operation key is disposed in a vicinity of the display unit. The display unit comprises a content display area that displays a setting for the function and a key input display area that displays the instruction to be input by the operation key. The control unit allows the instruction to be input by the operation key to be displayed in the key input display area and allows the code signal corresponding to the instruction displayed based on the input of the operation key to be output.

### CROSS REFERENCE TO RELATED APPLICATION

This application claims priority from Japanese Patent Application No. 2005-216566, filed on Jul. 26, 2005, the entire subject matter of which is incorporated herein by reference.

### TECHNICAL FIELD

Aspects of the present invention relate to a multi function device having a plurality of functions and comprising an operation key for inputting instructions for the functions, a display unit for displaying information on the functions, and a control unit for outputting a predetermined code signal based on the input of the operation key and controlling display contents of the display unit.

### BACKGROUND

Conventionally, a device integrally having a plurality of functions such as a printer function, a scan function, a copy function and a facsimile function has been practically used. The device having the plurality of functions is generally called a multi function device.

The multi function device comprises an image record unit for recording an image on a record sheet in order to realize the printer function, the copy functionor the facsimile function. The multi function device further comprises an image read unit for reading an image on a document in order to realize the scan function or the copy function.

When the printer function is performed, the multi function device operates the image record unit based on data transmitted from a computer or the like and records an image or a document based on the data on a record sheet. When the scan function is performed, the multi function device operates the image read unit, reads a desired image on a document, and converts the image into image data. The converted image data is transmitted to the computer or recorded in a record media. When the copy function is performed, the multi function device operates the image read unit, reads a desired image on a document, converts the image into image data, operates the image record unit, and records an image based on the image data on a record sheet. When the facsimile function is performed, the multi function device operates the image read unit, reads adesired image on a document, converts the image into image data, and transmits the image data through a modem, an NCU and a telephone line. The multi function device operates the image record unit and records facsimile data received through the modem, the NCU and the telephone number on a record sheet.

In the image record unit, an operation panel for inputting instructions or settings of various functions is provided. The operation panel is equipped with a plurality of operation keys and a display unit. A user operates the operation keys while confirming a guide or setting displayed on the display unit to use various functions of the multi function device. Such amulti function device requires miniaturization or slimness in order to reduce a setting space (for example, see JP-A-2005-80129)

### SUMMARY

As the number of functions realized by the multi function device has increased and the operation of the device has been diversified in each of the functions, the number of the instructions or the settings to be input has increased. As the number of the instructions or the settings to be input has increased, the number of the operation keys provided on the operation panel has increased. Meanwhile, the display part has enlarged in order to improve visibility. Accordingly, the operation keys and the display unit must be provided in a restricted space of a miniaturized device. There is a need for simplifying the input using the operation keys.

Aspects of the present invention provide a multi function device in which operation keys and a display unit are arranged in a narrow space and operability is improved.

According to an aspect of the present invention, there is provided a multi function device having a plurality of functions, comprising: an operation key that inputs an instruction for the function; a display unit that displays information on the function; and a control unit that outputs a predetermined code signal based on an input of the operation key and controls display contents of the display unit, wherein the operation key is disposed in a vicinity of the display unit, the display unit comprises a content display area that displays a setting for the function and a key input display area that displays the instruction to be input by the operation key, and the control unit allows the instruction to be input by the operation key to be displayed in the key input display area and allows the code signal corresponding to the instruction displayed based on the input of the operation key to be output.

The predetermined code signal is output from the control unit based on the input of the operation key. By performing the control corresponding to the output code signal, a predetermined function of the multi function device operates. The display unit has the content display area and the key input display area. Setting information on the functions is displayed in the content display area. The instruction which can be input by the operation key is displayed in the key input display area. Accordingly, a user can view the instruction displayed in the key input display area and confirm the input using the operation key.

According to the multi function device, since the instructions which can be input by the operation keys disposed in the vicinity of the display unit are displayed in the key input display area of the display unit, the user can recognize the instruction input by the operation key through the display of the key input display area. Particularly, since the instructions are displayed in the key input display area close to the operation keys, the user can view the display unit and easily understand the instructions which can be input by the operation keys. As a result, the operability of the device is improved.

Since the instructions has a layered structure, the instructions which can be input by the operation keys are separately displayed in the sub areas of the first display screen and the second display screen, and the plurality of instructions can be assigned to one operation key, the number of the operation keys becomes smaller than that of the instructions and, as a result, the space of the operation keys and the display unit can be reduced.

### BRIEF DESCRIPTION OF THE DRAWINGS

FIG. 1 is a perspective view showing an appearance of a multi function device according to an aspect of the present invention;

FIG. 2 is a cross-sectional view showing a configuration of a printer unit;

FIG. 3is a plan view showing a configuration of the printer unit;

FIG. 4 is a perspective view showing an appearance configuration of the multi function device in a state that a document cover is opened;

FIG. 5 is a plan view showing an internal configuration of a document mounting table;

FIG. 6 is a cross-sectional view showing the internal configuration of the document mounting table;

FIG. 7 is a plan view showing a configuration of a belt driving mechanism;

FIG. 8 is a block diagram showing a configuration of a control unit of the multi function device;

FIG. 9 is a planview showing a configuration of an operation panel;

FIG. 10 is a perspective view showing an appearance configuration of the multi function device in a state that a liquid crystal display unit is erected;

FIG. 11 is a side view showing a configuration in the vicinity of a shaft of the liquid crystal display unit;

FIG. 12 is a front view showing an appearance configuration of the multi function device in a state that the document mounting table is opened;

FIG. 13 is a plan view showing the liquid crystal display unit and operation keys in a standby state;

FIG. 14 is a flowchart showing main function selection;

FIG. 15 is a plan view showing the liquid crystal display unit and the operation keys in a media function;

FIG. 16 is a plan view showing the liquid crystal display unit and the operation keys in the media function;

FIGS. 17A and 17B are plan views showing the liquid crystal display unit and the operation keys in the media function;

FIGS. 18A and 18B are plan views showing the liquid crystal display unit and the operation keys in the media function;

FIGS. 19A and 19B are plan views showing the liquid crystal display unit and the operation keys in a copy function;

FIGS. 20A to 20C are plan views showing the liquid crystal display unit and the operation keys in a facsimile function; and

FIGS. 21A and 21B are plan views showing the liquid crystal display unit and the operation keys in a scan function.

### DETAILED DESCRIPTION

Hereinafter, aspects of the present invention will be described with reference to the accompanying drawings.

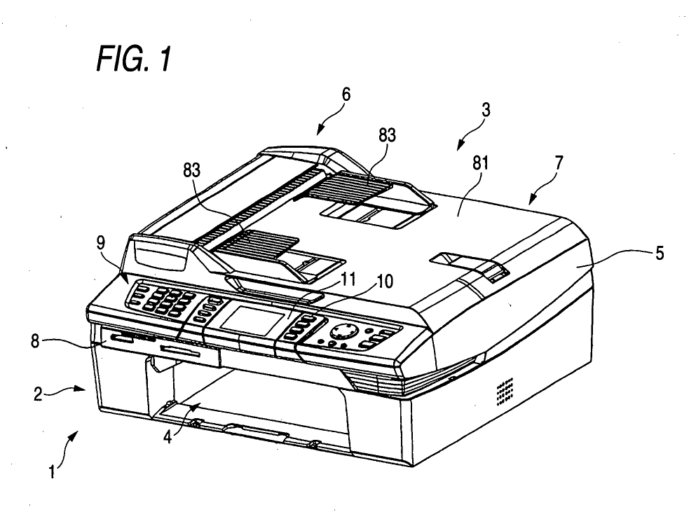

FIG. 1 is a perspective view showing an appearance of a multi function device 1 according to an aspect of the present invention. The multi function device (MDF) 1 integrally comprises a printer unit (image record unit) 2 located at a lower side thereof and a scanner unit (image read unit) 3 located at an upper side thereof and has a printer function, a scan function, a copy function and a facsimile function.

The multi function device 1 is connected to a computer (not shown) to record an image or a document on a record sheet based on image data or document data transmitted from the computer. The multi function device 1 is also connected to an external device such as a digital camera to record image data output from the digital camera on a record sheet or provided with a record medium such as a memory card to record image data recorded in the record medium on a record sheet. The below-described configuration of the multi function device 1 is only an example of an image recording apparatus related to the present invention and maybe appropriately changed without departing from the scope of the present invention.

(Printer Unit)

Hereinafter, the configuration of the printer unit 2 will be described. As shown in FIG. 1, an opening 4 is formed in the front side of the multi function device 1 and a feed tray 20 and an ejection tray 21 are mounted in the multi function device 1 through the opening 4. FIGS. 1, 4, 10 and 12 show the multi function device 1 in a state that the feed tray 20 and the ejection tray 21 are detached.

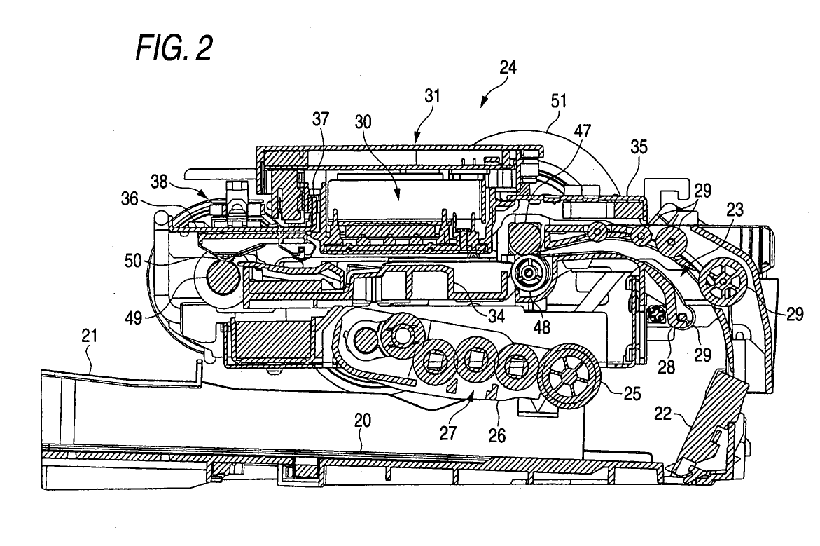

The feed tray 20 receives a record sheet (record medium) having a desired size such as an A4 size or a B5 size. As shown in FIG. 2, when the feed tray 20 is mounted in the multi function device 1, the longitudinal direction of the rectangular record sheet received in the feed tray 20 becomes the depth direction of the multi function device 1. The ejection tray 21 is supported by the feed tray 20 and disposed above the feed tray 20. The feed tray 20 and the ejection tray 21 form upper and lower stages and are mounted in the multi function device 1.

A separation slope plate 22 is disposed at the inside of the feed tray 20 mounted in the multi function device 1. The separation slope plate 22 separates the record sheet delivered from the feed tray 20 and guides the record sheet upward.

A carrying path 23 is provided above the separation slope plate 22. The carrying path 23 extends from the upper side of the separation slope plate 22 upward and bends to the front side of the multi function device 1 so as to extend from the rear side to the front side of the device. The carrying path 23 passes through the lower side of an image record part 24 and communicates with the ejection tray 21. The record sheet delivered from the feed tray 20 is guided to take a U-turn from the lower side to the upper side by the carrying path 23 and reaches the image record part 24. The record sheet on which an image is recorded at the image record part 24 is ejected to the ejection tray 21.

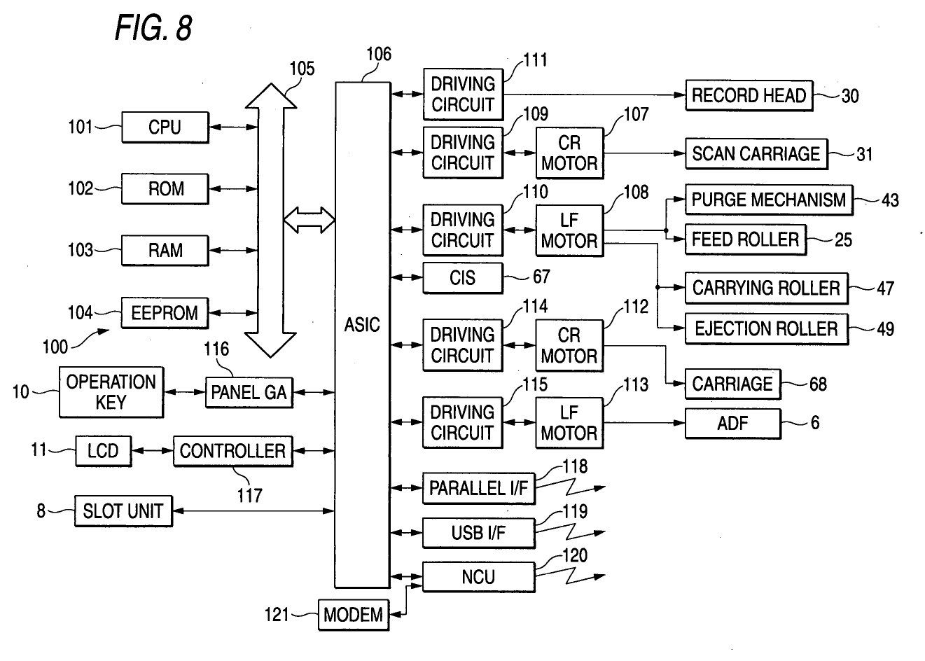

A feed roller 25 is provided above the feed tray 20. The feed roller 25 separates the record sheet stacked on the feed tray 20 one by one and feeds the record sheet to the carrying path 23. The feed roller 25 is rotatably supported by the top end of a feed arm 26 which vertically moves so as to come in contact with and separate from the feed tray 20. The feed roller 25 rotates by receiving a driving force of an LF motor 108 (see FIG. 8) through a driving force delivering mechanism 27 having a plurality of gears engaged with one another.

The feed arm 26 is disposed movably up and down around the base end side as a fulcrum. The feed arm 26 moves downward such that the feed roller 25 is pressed toward the feed tray 20 in a state that the feed tray 20 is mounted in the device. When the feed tray 20 is detached from the device, the feed arm 26 moves upward by a bias force of a spring. When the feed arm 26 moves downward, the feed roller 25 which is rotatably supported by the top end of the feed arm 26 closely comes in contact with the record sheet on the feed tray 20. In this state, when the feed roller 25 rotates, the record sheet located at an uppermost side is delivered to the separation slope plate 22 by a friction force between the roller surface of the feed roller 25 and the record sheet. The leading end of the record sheet comes in contact with the separation slope plate 22 to be guided upward and is delivered to the carrying path 23. Even when a record sheet located just below the uppermost sheet is delivered together by friction or static electricity, that record sheet comes in contact with the separation slop plate 22 and is inhibited from being delivered.

The carrying path 23 has an outer guide plane and an inner guide plane which face each other at a predetermined interval, except a place in which the image record part 24 is disposed. For example, in the carrying path 23 located at the rear side of the multi function device 1, the outer guide plane is integrally formed with a frame of the multi function device 1 and the inner guide plane is configured by fixing a guide member 28 in the frame. A carrying roller 29 is provided at a predetermined position of the carrying path 23, and, more particularly, a position in which the carrying path 23 is bent. The carrying roller 29 has a roller surface exposed from the outer guide plane or the inner guide plane and is formed to rotate in a width direction of the carrying path 23 as an axis direction. The record sheet which comes in contact with the guide plane at the position in which the carrying path 23 is bent is smoothly carried by the carrying roller 29.

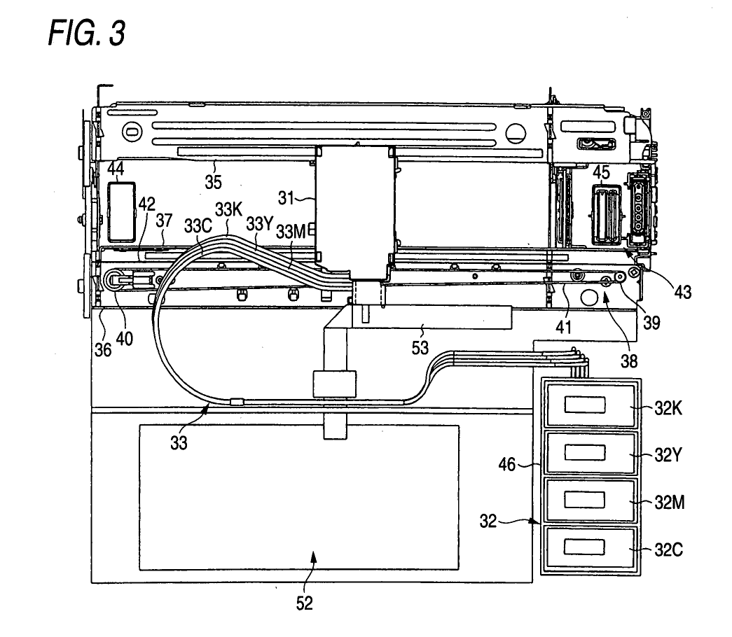

The image record part 24 comprises a scan carriage 31 which comprises a record head 30 and reciprocally moves in a main scan direction. In the record head 30, color inks of cyan (C), magenta (M), yellow (Y) and black (Bk) are supplied from an ink tank 32 (see FIG. 3) through ink tubes 33. The record head 30 ejects the respective inks as ink droplets through a nozzle provided at the lower side thereof. By reciprocally moving the scan carriage 31, the record head 30 is scanned with respect to the record sheet and an image is recorded on the record sheet carried onto a platen 34.

As shown in FIG. 3, a pair of guide rails 35 and 36 is disposed above the carrying path 23 in which the image record part 24 is disposed. The guide rails 35 and 36 are separated from each other in a carrying direction of the record sheet and extend in the width direction of the carrying path 23. The scan carriage 31 is slidably stretched over the guide rails 35 and 36. The guide rail 35 which is disposed at an upstream side of the carrying direction of the record sheet has a flat plate shape and the length of the guide rail 35 in the width direction of the carrying path 23 is larger than the scan width of the scan carriage 31. The up streamend of the scan carriage 31 is slidably loaded on the upper surface of the guide rail 35.

The guide rail 36 which is disposed at the downstream side of the carrying direction of the record sheet has a flat plate shape and the length of the guide rail 36 in the width direction of the carrying path 23 is substantially equal to that of the guide rail 35. The downstream end of the scan carriage 31 is slidably loaded on the upper surface of the guide rail 36. The upstream end 37 of the carrying direction of the guide rail 36 is substantially perpendicularly bent upward. The scan carriage 31 has a pair of rollers (not shown) between which the end 37 of the guide rail 36 is interposed. As a result, the scan carriage 31 is slidably loaded on the guide rails 35 and 36 and reciprocally moved in the width direction of the carrying path 23 relative to the end 37 of the guide rail 36. A sliding member for reducing the friction is properly provided at a position in which the scan carriage 31 comes in contact with the upper surfaces of the guide rails 35 and 36.

A belt driving mechanism 38 is disposed on the upper surface of the guide rail 36. The belt driving mechanism 38 is configured by stretching an endless annular timing belt 41, in which teeth are formed at the inside thereof, between a driving pulley 39 and a driven pulley 40 which are provided in the vicinities of the both ends of the width direction of the carrying path 23. A driving force is supplied from a CR motor 107 (see FIG. 8) to the shaft of the driving pulley 39. The timing belt 41 rotates by rotation of the driving pulley 39. As the timing belt 41, a belt of which the both ends are connected to the scan carriage 31 may be used, instead of the endless annular belt.

The scan carriage 31 is connected to the timing belt 41. The scan carriage 31 reciprocally moves on the guide rails 35 and 36 relative to the end 37 by the rotation of the timing belt 41. The record head 30 is mounted in the scan carriage 31. Accordingly, the record head 30 can reciprocally move together with the scan carriage 31 in the width direction of the carrying path 23 as the main scan direction. An encoder strip 42 of a linear encoder is disposed along the end 37 of the guide rail 36. The linear encoder detects the encoder strip 42 using a photo-interrupter. The reciprocal movement of the scan carriage 31 is controlled based on the detected signal of the linear encoder.

As shown in FIG. 2, the platen 34 which faces the record head 30 is disposed below the carrying path 23. The platen 34 is disposed over a central portion through which the record sheet passes in a reciprocal movement range of the scan carriage 31. The width of the platen 34 is sufficiently larger than the maximum width of the record sheet to be carried and the both ends of the record sheet are always delivered on the platen 34.

As shown in FIG. 3, a purge mechanism 43 and a waste ink tray 44 are disposed in a range that the record sheet does not pass at the both sides of the platen 34 (that is, the outside of the image record range of the record head 30). The purge mechanism 43 removes bubble or extraneous materials together with the ink from the nozzle of the record head 30. The purge mechanism 43, comprises a cap 45 for covering a nozzle surface of the record head 30. The cap 45 is connected to a pump mechanism. The cap 45 comes in contact with and separates from the nozzle surface of the record head 30 by a movement mechanism. When the bubble or the like is to be sucked and removed from the record head 30, the scan carriage 31 moves such that the record head 30 is positioned above the cap 45. In this state, the cap 45 moves upward to be closely covers the nozzle of the record head 30. The ink is sucked from the nozzle of the record head 30 by the pump connected to the cap 45.

The waste ink tray 44 is disposed at the opposite side of the purge mechanism 43 and the outside of the image record range of the scan carriage 31. The waste ink tray 44 receives the ink idly ejected from the record head 30. The idle ejection is called flushing. Maintenance such as removal of the bubble or mixed color inks in the record head 30 is performed by a maintenance unit comprising the purge mechanism 43 and the waste ink tray 44.

The ink tank 32 is received in an ink tank receiving part 46 which is provided in a casing located at the front right side of the printer unit 2. The ink tank 32 is provided in the device independent of the scan carriage 31, in which the record head 30 is mounted. The ink is supplied from the ink tank 32 to the scan carriage 31 through the ink tubes 33.

More specifically, the ink tank 32 comprises four ink tanks 32C, 32M, 32Y and 32K for storing color inks of cyan (C), magenta (M), yellow (Y) and black (Bk). The ink tanks 32C, 32M, 32Y and 32K are mounted at predetermined positions of the ink tank receiving part 46 provided in the casing of the device, respectively. The ink tanks 32C, 32M, 32Y and 32K are cartridge type tanks in which the color inks are filled in casings made of synthetic resin. The ink tanks 32C, 32M, 32Y and 32K can be attached or detached through the upper side of the ink tank receiving part 46.

The color inks are supplied from the ink tanks 32C, 32M, 32Y and 32K mounted in the ink tank receiving unit 46 to the record head 30 through the ink tubes 33 separately provided for each color, respectively. The ink tubes 33C, 33M, 33Y and 33K are made of synthetic resin and have flexibility so as to be bent according to the scanning of the scan carriage 31. Openings provided at one ends of the ink tubes 33C, 33M, 33Y and 33K are connected to connection points formed at the ink tank receiving positions of the ink tank receiving part 46. The ink tube 33C corresponds to the ink tank 32C and supplies the ink of cyan (C). Similarly, the ink tubes 33M, 33Y and 33K correspond to the ink tanks 32M, 32Y and 32K and supply the inks of magenta (M), yellow (Y) and black (Bk), respectively.

The ink tubes 33C, 33M, 33Y and 33K extend from the ink tank receiving part 46 to the vicinity of the central portion in the width direction of the device and are fixed to a member such as the frame of the device. The portions of the ink tubes from the fixed position to the scan carriage 31 are not fixed to the frame of the device or the like and move depending on the reciprocal movement of the scan carriage 31. That is, when the scan carriage 31 moves to one end (left side of FIG. 3) of the reciprocal movement direction, the ink tubes 33C, 33M, 33Y and 33K move in the movement direction of the scan carriage 31 and bend such that the bending radius of a U-shaped curved portion decreases. Meanwhile, when the scan carriage 31 moves to the other end (right side of FIG. 3) of the reciprocal movement direction, the ink tubes 33C, 33M, 33Y and 33K move in the movement direction of the scan carriage 31 and bend such that the bending radius of the U-shaped curved portion increases.

As shown in FIG. 2, a pair of a carrying roller 47 and a pinch roller 48 is provided at the upstream side of the image record part 24. The record sheet carried in the carrying path 23 is inserted between the carrying roller 47 and the pinch roller 48 to be carried onto the platen 34. Meanwhile, a pair of ejection roller 49 and a spur roller 50 is provided at the downstream side of the image record part 24. The record sheet, on which an image is recorded, is inserted between the ejection roller 49 and the spur roller 50 to be carried. The carrying roller 47 and the ejection roller 49 receive a driving force delivered from the LF motor 108 (see FIG. 8) and are intermittently driven with a predetermined line feed width. The carrying roller 47 and the ejection roller 49 rotate in synchronization with each other. A rotary encoder detects an encoder disc 51 provided in the carrying roller 47 using a photo-interrupter and the rotation of the carrying roller 47 and the ejection roller 49 is controlled by the detected signal of the rotary encoder.

The pinch roller 48 is rotatably provided to press the carrying roller 47 with a predetermined press force. When the record sheet is introduced between the carrying roller 47 and the pinch roller 48, the pinch roller 48 retreats by the thickness of the record sheet such that the record sheet is inserted between the pinch roller 48 and the carrying roller 47. As a result, the rotation force of the carrying roller 47 is surely delivered to the record sheet. Similarly, the spur roller 50 is provided with respect to the ejection roller 49, but the roller surface thereof is provided with irregularities such that an image recorded on the record sheet does not deteriorate, because the spur roller 50 comes in contact with the record sheet on which the image is recorded.

The record sheet inserted between the carrying roller 47 and the pinch roller 48 is intermittently carried on the platen 34 with the predetermined line feed width. The record head 30 is scanned for each line feed and an image is recorded from the leading end of the record sheet. The leading end of the recorded sheet on which the image is recorded is inserted between the ejection roller 49 and the spur roller 50. That is, the recorded sheet is intermittently carried with the predetermined line feed width in a state that the front end thereof is inserted between the ejection roller 49 and the spur roller 50 and the trailing end thereof is inserted between the carrying roller 47 and the pinch roller 48, and, as a result, the image is recorded on the record sheet by the record head for each line feed. When the record sheet is carried, the trailing end of the record sheet escapes from the carrying roller 47 and the pinch roller 48. That is, the record sheet is inserted between the ejection roller 49 and the spur roller 50 and intermittently carried with the predetermined line feed width such that the image is recorded thereon by the record head 30 for each line feed. After the image is recorded in a predetermined area of the record sheet, the ejection roller 49 rotates continuously. As a result, the record sheet inserted between the ejection roller 49 and the spur roller 50 is ejected to the ejection tray 21.

As shown in FIG. 3, a control board 52 is disposed at the front side of the device. A record signal is transmitted from the control board 52 to the record head 30 through a flat cable 53. The flat cable 53 is a thin band shape cable obtained by covering a synthetic resin film such as a polyester film on a conductor for transmitting an electric signal. The control board 52 and the control board (not shown) of the record head 30 are electrically connected to each other by the flat cable 53. The flat cable 53 extends from the scan carriage 31 in the reciprocal movement direction and vertically bends in a substantially U shape. The substantial U-shaped portion of the flat cable is not fixed to the other member and moves according to the reciprocal movement of the scan carriage 31.

(Scanner Unit)

Hereinafter, a configuration of the scanner unit 3 will be described in detail.

As shown in FIGS. 1, 4 and 5, in the scanner unit 3, a document cover 7 comprising an auto document feeder (ADF) is openably attached to a document mounting table 5 which functions as a flat bed scanner (FBS) through a hinge located at a rear side thereof. The document mounting table 5 is the casing of the multi function device 1 and configures a portion of the upper surface of the device. The document cover 7 also configures a portion of the upper surface of the device. Since the present aspect is not directly associated with the structure and the function of the ADF 6, a document carrying opening for the ADF 6 (opening for exposing the document image surface) is omitted from illustration.

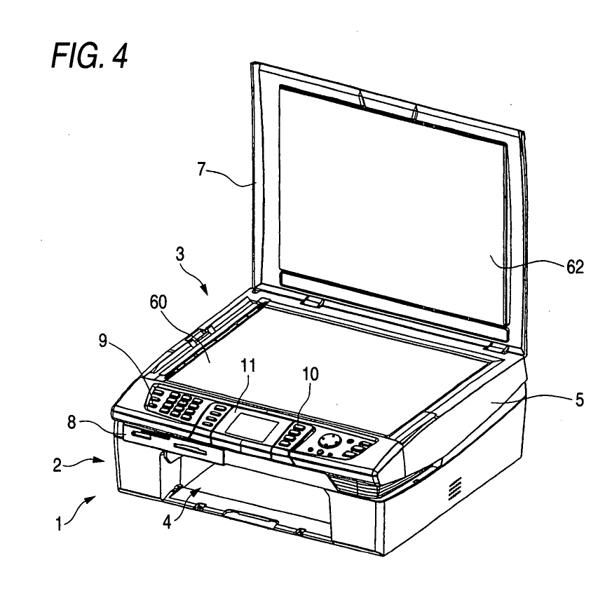

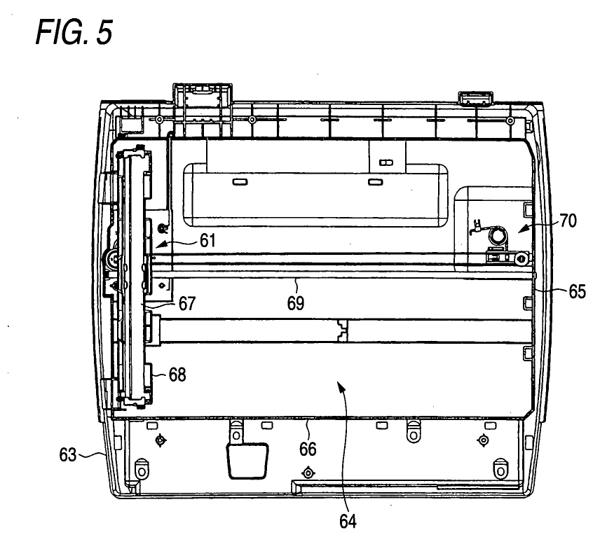

As shown in FIG. 4, a platen glass 60 is disposed on the upper surface of the document mounting table 5 and, as shown in FIG. 1, the platen glass 60 is covered by the document cover 7 in a state that the document cover 7 is closed. In this state, the document cover configures the portion of the upper surface of the device. A press member 62 made of sponge or white sheet is disposed on the lower surface of the document cover 7 so as to press the document loaded on the platen glass 60. As shown in FIG. 5, an image read part 61 is mounted in the document mounting table 5. When the scanner unit 3 is used as the FBS, the document cover 7 is opened and the document is loaded on the platen glass 60. The document having the A4 size or less can be loaded on the platen glass 60 and the document is loaded on the platen glass 60 such that the longitudinal direction of the rectangular document is parallel to the width direction of the multi function device 1. The document cover 7 is closed and the document is fixed on the platen glass 60. The image read part 61 is scanned along the platen glass 60 such that the image on the document is read using the FBS.

When the scanner unit 3 is used as the FBS, the platen glass 60 is used to load the document and, for example, made of a transparent glass plate. One end of the platen glass 60 reaches the lower side of the document carrying roller 98 (see FIG. 8) and configures a read surface when the image is read using the ADF 6.

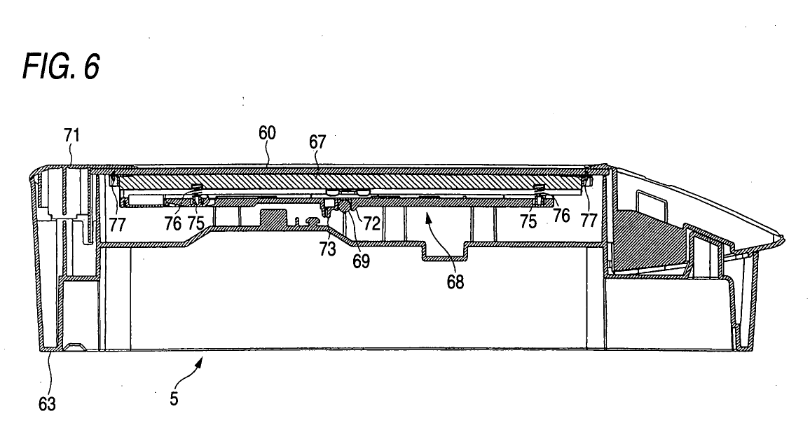

FIG. 5 shows an internal configuration of the document mounting table 5. The image read part 61 is disposed in a lower frame 63 of the casing of the document mounting table 5. An upper cover 71 (see FIG. 6) in which an opening for exposing the platen glass 60 is formed at the central portion thereof is engaged with the lower frame 63 to configure the casing of the document mounting table 5. Both the lower frame 63 and the upper cover 71 are made of synthetic resin. The lower frame 63 integrally comprises a base part 64 for configuring a bottom plate, side walls 65 which are erected at the peripheral portion of the base part 64 and a partitioning plate 66 for partitioning a portion in which the image read part 61 is disposed and a portion in which an operation panel 9 is disposed. In the lower frame 63, a supporting rib for supporting the platen glass 60, a boss part for threadably fixing various members and a through-hole for an electric wiring are formed and may be adequately designed according to the aspect of the document mounting table 5 and their detailed description will be omitted.

The image read part 61 comprises a contact image sensor 67, a carriage 68, a guide shaft 69 and a belt driving mechanism 70. The contact image sensor 67 is a contact type image sensor for irradiating light on to a document using a light source, guiding the light reflected from the document to a photoelectric converting element by a lens and outputting an electric signal using the photoelectric converting element according to the intensity of the reflected light. The contact image sensor 67 is mounted in the carriage 68 and reciprocally moves below the platen glass 60. The carriage 68 is fitted with the guide shaft 69 which extends over the width direction of the lower frame 63, is driven by the belt driving mechanism 70, and is slidably moved on the guide shaft 69. The carriage 68 moves the contact image sensor 67 on the guide shaft 69 in a state that the contact image sensor 67 is closely in contact with the platen glass 60 and, as a result, the contact image sensor 67 moves in parallel to the platen glass 60.

As shown in FIG. 6, the contact image sensor 67 is mounted on the carriage 68. A shaft receiving part 72 is provided at the lower surface of the carriage 68 such that the shaft receiving part 72 is stretched over and fitted to the guide shaft 69. The shaft receiving part 72 is fitted to the guide shaft 69 and the carriage 68 is loaded on the guide shaft 69 such that the carriage 68 slides in the axis direction of the guide shaft 69. A belt gripping part 73 is protruded from the side of the shaft receiving part 72 downward. The belt gripping part 73 grips the timing belt 74 of the belt driving mechanism 70 such that the timing belt 74 is connected to the carriage 68. Accordingly, the driving force is delivered from the belt driving mechanism 70 to the carriage 68 and the carriage 68 moves on the guide shaft 69.

Spring receiving parts 75 are formed in two left and right sides of the carriage 68. Coil springs 76 which are positioned by the spring receiving part 75 are interposed between the contact image sensor 67 and the carriage 68. The contact image sensor 67 mounted in the carriage 68 is brought into close contact with the lower surface of the platen glass 60 by the coil springs 76. Rollers 77 are formed at the both sides of the contact image sensor 67. The contact image sensor 67 which is pressed by the lower surface of the platen glass 60 smoothly moves while being closely contacted with the lower surface of the platen glass 60 by the rollers 77 according to the movement of the carriage 68.

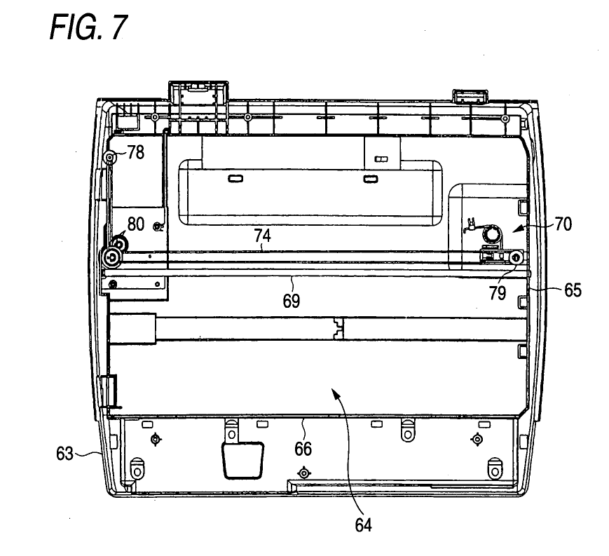

As shown in FIG. 7, the belt driving mechanism 70 comprises the timing belt 74 stretched between a driving pulley 78 and a driven pulley 79. The timing belt 74 is an endless belt having teeth therein. The rotation force of a CR motor 112 (see FIG. 8) is output to the shaft of the driving pulley 78. The timing belt 74 rotates by the rotation force of the driving pulley 78. The driving pulley 78 is disposed in the left rear side of the lower frame 63. The timing belt 74 stretched over the driving pulley 78 has an L shape and extends to the front side of the lower frame 63, substantially perpendicularly bends around an intermediate pulley 80 disposed in front of the guide shaft 69, extends to the right end of the lower frame 63 and winds around the driven pulley 79 disposed in the vicinity of the right end thereof. A portion between the driven pulley 79 and the intermediate pulley 80 of the timing belt 74, that is, a portion which extends along the guide shaft 69, is gripped by the belt gripping port 73 of the carriage 68. As a result, the timing belt 74 and the carriage 68 are connected to each other. As the timing belt 74, a belt of which the both ends are connected to the carriage 68 may be used instead of the endless belt.

As shown in FIG. 1, the document cover 7 comprises the ADF 6 for continuously carrying the document from a document tray 81 to an ejection tray 83 through a document carrying path formed in the ADF 6. At the time of carrying the document using the ADF 6, the document passes thorough the read surface of the platen glass 60 such that the image read part 61 disposed below the read surface reads the document. In the present aspect, the ADF 6 is optional and the scanner unit 3 may read the image only using the FBS without the ADF 6. Accordingly, the detailed description on the ADF 6 will be omitted.

When the scanner unit 3 is used as the FBS, the carriage 68 moves below the platen glass 60 in parallel to the platen glass 60 and a contact image sensor 82 mounted on the carriage 68 reads the image on the document loaded on the platen glass 60. When the ADF 6 is used, the carriage 68 moves to the lower side of the read surface of the platen glass 60 and stops and the contact image sensor 82 reads the image on the document which passes through the read surface.

Although, in the present aspect, the contact image sensor 82 is used as the-image read part 61, an image sensor for a reduction optical system such as a charge coupled device (CCD) may be used instead of the contact image sensor 82. Even in this case, the effect of the present aspect is obtained.

(Control Unit)

Hereinafter, a control unit for controlling the operations of the printer unit 2 and the scanner unit 3 will be described. FIG. 8 shows a configuration of the control unit 100 of the multi function device 1. The control unit 100 controls the operation of the multi function device 1 comprising the printer unit 2 and the scanner unit 3. As shown, the control unit 100 is a microcomputer which mainly comprises a central processing unit (CPU) 101, a read only memory (ROM) 102, a random access memory (RAM) 103, an electrically erasable and programmable ROM (EEPROM) 104 and is connected to an application specific integrated circuit (ASIC) 106 through a bus 105.

The ROM 102 stores a program for controlling various operations of the multi function device 1. The RAM 103 is used as a storage area or a work area for temporarily recording various data used for executing the program.

The ASIC 106 generates a phase excitation signal for energizing the CR motor 107 or the LF motor 108 of the printer unit 2 according to an instruction of the CPU 101 and supplies the signal to a driving circuit 109 or 110 of the CR motor 107 or the LF motor 108. The driving signal is supplied to the CR motor 107 or the LF motor 108 through the driving circuit 109 or 110 such that the rotation of the CR motor 107 or the LF motor 108 is controlled.

The driving circuit 109 drives the CR motor 107 connected to the scan carriage 31 of the printer unit 2. The driving circuit 109 receives an output signal from the ASIC 106 and generates an electric signal for rotating the CR motor 107. The CR motor 107 which receives the electric signal rotates, the rotation force of the CR motor 107 is delivered to the scan carriage 31 through the belt driving mechanism 38, and, as a result, the scan carriage 31 is scanned.

The driving circuit 110 drives the LF motor 108 connected to the feed roller 25, the carrying roller 47, the ejection roller 49 and the purge mechanism 43 of the printer unit 2. The driving circuit 110 receives an output signal from the ASIC 106 and generates an electric signal for rotating the LF motor 108. The LF motor 108 which receives the electric signal rotates and the rotation force of the LFmotor 108 is delivered to the feed roller 25, the carrying roller 47, the ejection roller 49 and the purge mechanism 43 through a known driving mechanism comprising a gear or a driving shaft.

The driving circuit 111 allows the ink to be selectively ejected from the record head 30 to the record sheet at a predetermined timing. The driving circuit 111 receives an output signal generated at the ASIC 106 and drives the record head 30 based on a driving control sequence output from the CPU 101.

The ASIC 106 is connected with the rotary encoder for detecting the rotation amount of the carrying roller 47 of the printer unit 2 and the linear encoder for detecting the movement amount of the scan carriage 31. The CPU 101 outputs an instruction to the ASIC 106 based on the detected signal of the rotary encoder or the linear encoder and the ASIC 106 generates the phase excitation signals for respectively energizing the CR motor 107 and the LF motor 108.

The ASIC 106 generates the phase excitation signals for respectively energizing the CR motor 112 of the scanner unit 3 and the LF motor 113 of the ADF 6 according to the instruction the CPU 101 and supplies the signals to the driving circuits 114 and 115 of the CR motor 112 and the LFmotor 113. The driving signals is supplied to the CR motor 112 and the LF motor 113 through the driving circuits 114 and 115 such that the rotations of the CR motor 112 and the LF motor 113 are controlled.

The driving circuit 114 drives the CR motor 112 connected to the carriage 68 of the scanner unit 3. The driving circuit 114 receives an output signal from the ASIC 106 and generates an electric signal for rotating the CR motor 112. The CR motor 112 which receives the electric signal rotates, the rotation force of the CR motor 112 is delivered to the carriage 68 through a known scan mechanism, and, as a result, the carriage 68 moves.

The driving circuit 115 drives the LF motor 113 connected to the driving portion such as the carrying roller of the ADF 6. The driving circuit 115 receives an output signal from the ASIC 106 and generates an electric signal for rotating the LF motor 113. The LF motor 113 which receives the electric signal rotates and the rotation force of the LF motor 113 is delivered to the carrying roller 25 of the ADF 6 through a known driving mechanism comprising a gear or a driving shaft.

The ASIC 106 is connected to the contact image sensor 67 for reading the image on the document in the scanner unit 3. The ASIC 106 supplies an electric signal for irradiating the light by the light source of the contact image sensor 67 or a timing signal for outputting image data from the photoelectric converting element to the contact image sensor 67 based on the instruction of the CPU 101. The contact image sensor 67 receives this signal, irradiates the light onto the document at a predetermined timing, and outputs the image data converted by the photoelectric converting element.

The ASIC 106 is connected to a panel gate array 116 which controls operation keys 10 for inputting a desired instruction to the multi function device 1. The panel gate array 116 detects the pressing of the operation key 10 and outputs a predetermined code signal. Key codes are assigned in correspondence with a plurality of operation keys 10 and, more particularly, a plurality of key codes are assigned to the operation keys 10 disposed in the vicinity of a liquid crystal display unit (display unit) 11 in association with the display of the liquid crystal display unit 11. When the CPU 101 receives the predetermined key code from the panel gate array 116, the CPU 101 performs a control process to be executed according to a predetermined key process table. The key process table shows a correspondence between the key codes and control processes and is, for example, stored in the ROM 102.

The ASIC 106 is connected to a LCD controller 117 for controlling screen display of the liquid crystal display unit 11. The LCD controller 117 allows the liquid crystal display unit 11 to display information on the operation of the printer unit 2 or the scanner unit 3 on a screen based on the instruction of the CPU 101.

The ASIC 106 is connected to a slot part 8, into which various small-sized memory cards are inserted, and a parallel interface 118 and USB interface 119 for transmitting/receiving data to/from a computer through a parallel cable or a USB cable. The ASIC 106 is connected to a network control unit (NCU) 120 for realizing a facsimile function or a MODEM 121.

(Operation Panel)

Hereinafter, an operation panel of the multi function device 1 will be described. As shown in FIG. 1, the operation panel 9 is provided on the front side of the document mounting table 5. The operation panel 9 comprises the various operation keys 10 and the liquid crystal display unit 11. A user inputs a desire instruction using the operation panel 9. The multi function device 1 receives the input and performs a predetermined operation. The multi function device 1 may be connected to a computer and operated according to an instruction transmitted from the computer through a printer driver or a scanner driver, in addition to the input instruction.

The slot part 8 into which the various small-sized memory cards of record mediums are inserted is provided in the left upper side of the front surface of the multi function device 1. Image data recorded in the small-sized memory card inserted into the slot part 8 is read and information on the image data is displayed on the liquid crystal display unit 11, and any image is recorded on the record sheet by the printer unit 3. The input for performing this operation is realized using the operation panel 9.

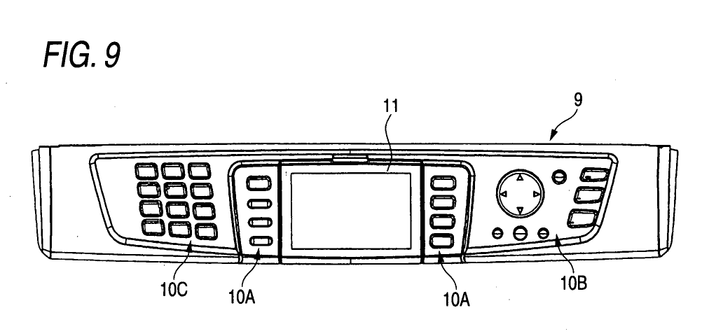

As shown in FIG. 9, the liquid crystal display unit 11 has a rectangular shape and extends horizontally when viewed in a plan view and the vertical size thereof is slightly smaller than the width of the operation panel 9. Accordingly, there is no space for disposing the operation keys 10 in the front and rear of the liquid crystal display part 11 in the operation panel 9. That is, the liquid crystal display unit 11 enlarges enough to allow the liquid crystal display unit 11 to be disposed in the operation panel 9. By using such a large-sized liquid crystal display part 11, visibility of characters or images displayed on the liquid crystal display unit 11 is improved.

The liquid crystal display unit 11 is disposed at the central portion of the width direction of the operation panel 9. The width of the liquid crystal display unit 11 is sufficiently smaller than that of the operation panel 9. Accordingly, there is a space for disposing the operation keys 10 on the sides of the liquid crystal display unit 11 in the operation panel 9. By disposing the liquid crystal display unit 11 at the central portion of the operation panel 9, the operation keys 10 can be disposed on the left and right sides of the liquid crystal display unit 11. Accordingly, the positional balance of the liquid crystal display part 11 for the arrangement of the operation keys 10 is improved.

The operation keys 10 are divided into three keys comprising operation keys 10A formed in the vicinity of the liquid crystal display unit 11, operation keys 10B formed at the right end of the operation panel 9 and operation keys 10C formed at the left end of the operation panel 9.

The operation keys 10A are arranged in a row on each of the left and right sides of the liquid crystal display unit 11 in the vicinity of the liquid crystal display unit 11. By disposing the operation keys 10A on the left and right side of the liquid crystal display unit 11, the space of the both sides of the liquid crystal display unit 11 can be efficiently used.

The operation keys 10A are mode keys for switching the facsimile mode, the copy mode, the scan mode and so on and also function as setting keys for performing various settings in the respective modes. That is, since a plurality of inputs are assigned to the operation keys 10A, the input contents are displayed on the liquid crystal display unit 11 by pressing the operation keys 10A. The relationship between the operation keys 10A and the liquid crystal display unit 11 will be described later.

The operation keys 10B comprises a power key for turning on/off the multi function device 1, a navigation key for searching for a telephone number or a speed dial registered in the control unit 100, changing a telephone volume or the volume of warning sound or input confirmation sound and determining various settings, a start key for inputting the start of image record or image read, a stop key for inputting the stop of various processes, and so on. The operation keys 10C comprise dial keys for inputting the telephone number and so on. The kinds of the operation keys 10B and the operation keys 10C are only exemplary and the operation keys of the present aspect are not limited thereto.

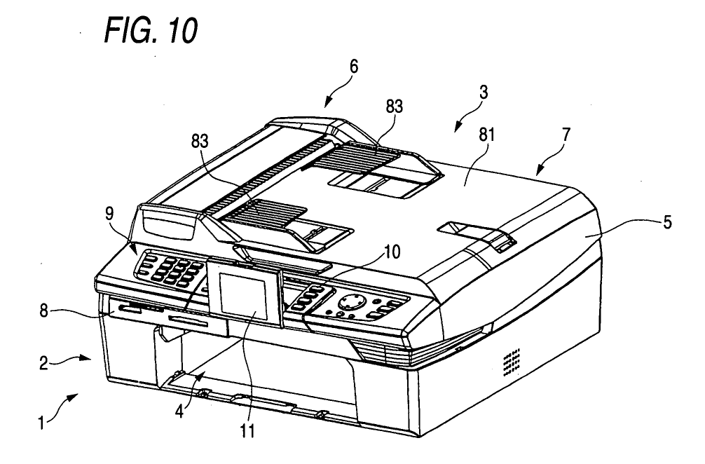

As shown in FIG. 1, the liquid crystal display unit 11 is laid on the operation panel 9 such that the surface of the liquid crystal display unit 11 and the surface of the operation panel 9 become substantially flush. This posture of the liquid crystal display unit 11 is called a laid posture. Meanwhile, the liquid crystal display unit 11 can rotate such that the liquid crystal display unit 11 is erected with respect to the operation panel 9, as shown in FIG. 10. This posture of the liquid crystal display unit 11 is called an erected posture. When the liquid crystal display unit 11 is in the laid posture, the liquid crystal display unit 11 is not protruded from the surface of the operation panel 9 and, as a result, the appearance of the operation panel 9 is improved. In addition, the display visibility of the liquid crystal display unit 11 from the upper side of the multi function device 1 is improved. Meanwhile, when the liquid crystal display unit 11 is in the erected posture, the display visibility of the liquid crystal display unit 11 from the front surface of the multi function device 1 is improved.

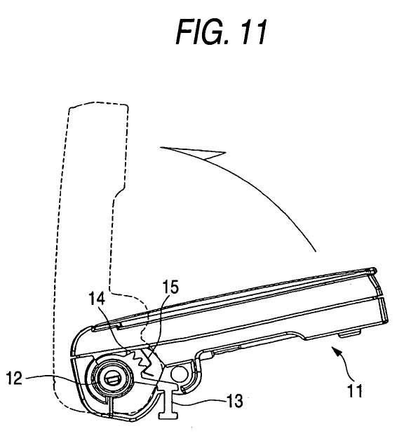

The rotation of the liquid crystal display unit 11 is realized by pivotably supporting the shaft 12 (see FIG. 11) provided in the liquid crystal display unit 11 on the document mounting table 5. The liquid crystal display unit 11 is configured by disposing a liquid crystal display (LCD) in a casing having a predetermined thickness and a flat board shape such that the LCD can be viewed from the front side. Although not shown, the flat cable extends from the rear surface of the liquid crystal display unit 11 and is connected to the control board 52 (see FIG. 3). Accordingly, the liquid crystal display unit 11 receives an electric signal from the control board 52 such that a predetermined screen is displayed on the liquid crystal display.

As shown in FIG. 11, the shaft 12 is protruded from the side surface of the casing of the liquid crystal display unit 11 laterally. By pivotably supporting the shaft 12 in the vicinity of the central portion of the operation panel 9 of the document mounting table 5, the liquid crystal display unit 11 can rotate around the shaft 12. The shaft 12 is protruded from the vicinity of the lower corner of the thickness direction in a horizontal direction (the near side of the FIG. 11) at the front side (left side of FIG. 11) of the device in the laid posture. Although not shown, the shaft 12 is also provided at the opposite side surface of the liquid crystal display unit 11.

As shown in FIG. 11, an engagement member 13 is disposed to be fitted to the upper side of the shaft 12 of the liquid crystal display unit 11 which is pivotably supported to the document mounting table 5. In a state that the liquid crystal display unit 11 is pivotably supported to the document mounting table 5, the engagement member 13 is fixed to the document mounting table 5. The engagement member 13 has a plurality of locking claws 14 which is arranged in the circumferential direction of the shaft 12. A leaf spring 15 which is bent in a mountain shape is protruded from the liquid crystal display unit 11 such that the top end thereof is fitted between the adjacent locking claws 14.

As shown in FIG. 11, when the liquid crystal display unit 11 is in the laid posture, the leaf spring 15 is fitted between the locking claws 14 of the laid side end. In order to rotate the liquid crystal display unit 11 from the laid posture to the erected posture, the mountain-shaped top end of the leaf spring 15must be elastically deformed from the front end of the locking claw 14 to the outside of the diameter direction of the shaft 12. In other words, when a force for elastically deforming the leaf spring 15 is not applied to the liquid crystal display unit 11, the liquid crystal display unit 11 does not rotate. Accordingly, the liquid crystal display unit 11 which is in the laid posture is prevented from being fluctuated in the rotation direction.

When the user rotates the liquid crystal display unit 11 from the laid posture to the erected posture while gripping the front end of the liquid crystal display unit 11, the top end of the leaf spring 15 is elastically deformed to the outside of the diameter direction of the shaft 12 along the locking claw 14 by the rotation force applied by the user. When the top end of the leaf spring 15 goes over the front end of the locking claw 14 of the laid side end, the mountain-shaped top end of the leaf spring 15 is fitted to a valley between the locking claw 14 and the locking claw 14 adjacent thereto and is restored to the inside of the diameter direction of the shaft 12. In order to rotate the liquid crystal display unit 11 to the erected posture or the laid posture in the state that the top end of the lead spring 15 is fitted to the valley between the locking claws 14, a force for elastically deforming the mountain-shaped top end of the leaf spring 15 from the front end of the locking claw 14 to the outside of the diameter direction of the leaf spring 15 must be applied. In other words, unless the user further rotates the liquid crystal display unit 11, the liquid crystal display unit 11 is maintained in the state that the top end of the leaf spring 15 is fitted to the valley between the locking claws 14.

When the user rotates the liquid crystal display unit 11 again, the top end of the leaf spring 15 is elastically deformed along the locking claw 14 to the outside of the diameter direction of the shaft 12 and, when the top end of the leaf spring 15 goes over the front end of the locking claw 14, the mountain-shaped top end of the leaf spring 15 is fitted to a valley between the locking claw 14 and the locking claw 14 adjacent thereto and is restored to the inside of the diameter direction of the shaft 12. Unless the user further rotates the liquid crystal display unit 11, the liquid crystal display unit 11 is maintained in the state that the top end of the leaf spring 15 is fitted to the valley between the locking claws 14. The posture of the liquid crystal display unit 11 is maintained in a predetermined rotation position by the fitness between the locking claw 14 and the leaf spring 15. That is, it is possible to realize a tilt mechanism for temporarily fixing any posture in which the leaf spring 15 is fitted between the locking claws 14.

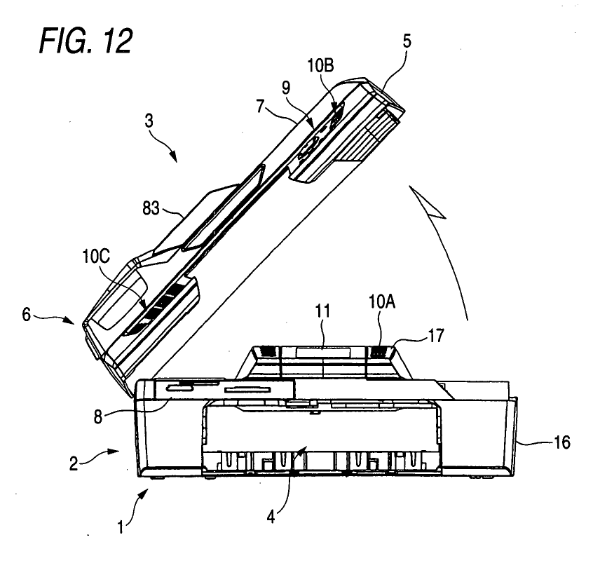

As shown in FIG. 12, the document mounting table 5 can rotate to be opened from the lower portion of the device which configures the printer unit 2 upward. The document mounting table 5 is connected to the side of the casing 16 of the lower portion of the device through a hinge mechanism. The document mounting table 5 can move relative to the casing 16 by the hinge mechanism.

As shown in FIG. 12, when the document mounting table 5 is opened upward, the inside of the casing 16, that is, the inside of the printer unit 2, is exposed. In this state, maintenance such as replacement of the ink tank 32 or jam recovery of the carrying path 23 can be performed. Since the operation panel 9 is provided on the front side of the document mounting table 5, the operation panel 9 rotates together with the document mounting table 5. Meanwhile, among the operation panel 9, a portion for pivotably supporting the liquid crystal display unit 11, that is, the both sides of the liquid crystal display unit 11, does not rotate together with the document mounting table 5 and is fixed to the casing 16. This portion is referred to as a fixed portion 17.

In order to rotate the liquid crystal display unit 11 relative to the operation panel 9, the portion for pivotaly supporting the shaft 12 (fixed portion 17) must be formed on the operation panel 9. By disposing the operation keys 10A in the fixed portion 17, the space of the fixed portion at the both sides of the liquid crystal display unit 11 is efficiently used.

Hereinafter, a relationship between the operation keys 10A and the display of the liquid crystal display unit 11 will be described. The liquid crystal display unit 11 displays instructions which can be input by the operation keys 10A in areas adjacent to the operation keys 10A, that is, left and right areas of the screen of the liquid crystal display unit 11, in association with the operation keys 10A. Accordingly, the user can recognize the instructions which can be input by pressing the operation keys 10A by the display of the liquid crystal display unit 11.

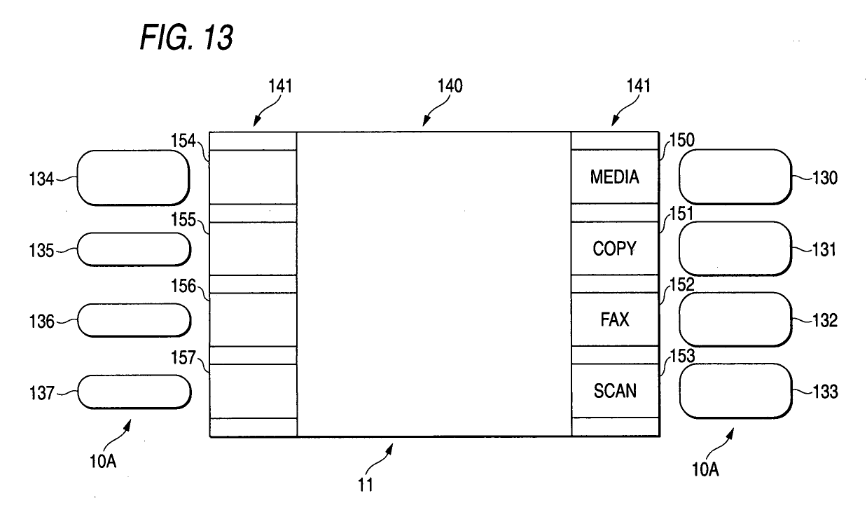

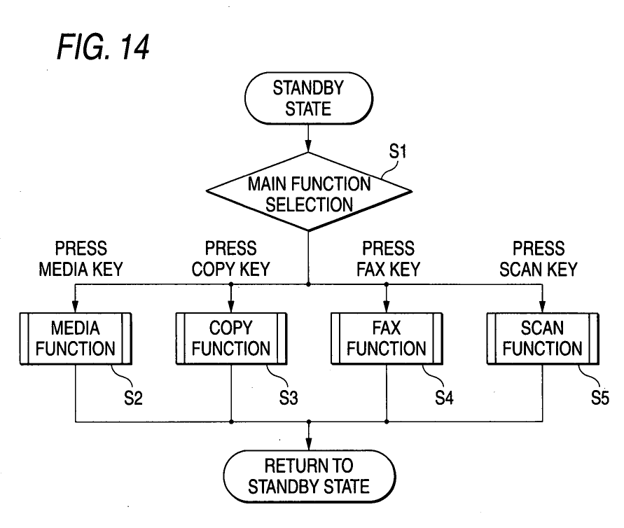

As shown in FIG. 13, four operation keys 10A are arranged on each of the left and right sides of the liquid crystal display unit 11. The four operation keys 130, 131, 132 and 133 which are arranged on the right side of the liquid crystal display unit 11 are mode keys and, as shown in FIG. 14, main function selection of the multi function device 1 is performed by pressing any one of these operation keys 130, 131, 132 and 133 (S1). A media function (S2), a copy function (S3), a facsimile function (S4) or a scan function (S5) is set by pressing any one of the operation keys 130, 131, 132 and 133. The four operation keys 134, 135, 136 and 137 which are arranged on the left side of the liquid crystal display unit 11 are used when various settings are input or the screen is transferred in the functions.

As shown in FIG. 13, the screen of the liquid crystal display unit 11 has a content display area 140 and a key input display area 141. The content display area 140 is disposed at the central portion of the screen. On the content display area 140, current date or time is displayed in a standby state and various settings or images are displayed in the respective functions. The key input display area 141 is disposed at the left and right ends of the screen. The key input display area 141 is to display the instructions which can be input by the operation keys 130 to 137. In the present aspect, since the operation keys 130 to 137 are disposed on the left and right sides of the liquid crystal display unit 11, the key input display area 141 is disposed at the left and right ends of the screen. When the operation keys are disposed only on any one side of the liquid crystal display unit 11, the key input display area 141 is disposed at any one end of the screen. The content display area 140 and the key input display area 141 need not be apparently separated from each other in the screen of the liquid crystal display unit 1. For example, the key input display area 140 or the below-described sub areas 150 to 157 may be provided in the content display area 140.

The arrangement of the key input display area 141 is not limited to the left and right sides of the screen. Like the present aspect, when the liquid crystal display unit 11 has a rectangular shape and extends horizontally, the key input display area 141 is arranged at the left and right ends of the screen of the liquid crystal display unit 11 such that the content display area 140 and the key input display area 141 are easily viewed together. Since the operation keys 130 to 137 and the liquid crystal display unit 11 extend horizontally, the efficiency of the space is improved when the operation keys 130 to 137 and the liquid crystal display unit 11 are disposed at the front side of the multi function device 1.

The key input display area 141 is divided into the sub areas 150 to 157 in correspondence with the operation keys 130 to 137. In the sub areas 150 to 157, the instructions which can be input by the closest operation keys 130 to 137, respectively, are displayed. That is, the key input display area 141 located at the right side of the screen has four sub areas 150 to 153 divided vertically in correspondence with the four operation keys 130 to 133 which are vertically disposed on the right side of the screen in a row. The sub area 150 corresponds to the operation key 130, the sub area 151 corresponds to the operation key 131, the sub area 152 corresponds to the operation key 132, and the sub area 153 corresponds to the operation key 133.

The key input display area 141 located at the left side of the screen has four sub areas 154 to 157 divided vertically in correspondence with the four operation keys 134 to 137 which are vertically disposed on the left side of the screen in a row. The sub area 154 corresponds to the operation key 134, the sub area 155 corresponds to the operation key 135, the sub area 156 corresponds to the operation key 136, and the sub area 157 corresponds to the operation key 137. As a result, when user presses any one of the plurality of operation keys 130 to 137, the user can recognize which instruction is input by the display of the sub areas 150 to 157.

FIG. 13 shows the screen display (first display screen) of the multi function device 1 in the standby state. Although not shown, current date or time is displayed in the content display area 140. “Media” is displayed in the sub area 150. This means that the media function is performed by pressing the operation key 130. “COPY” is displayed in the sub area 151. This means that the copy function is performed by pressing the operation key 131. “FAX” is displayed in the sub area 152. This means that the facsimile function is performed by pressing the operation key 132. “SCAN” is displayed in the sub area 153. This means that the scan function is performed by pressing the operation key 133.

Although the displays of the sub areas 154 to 157 are not specially shown, when the instruction input by pressing any one of the operation keys 134 to 137 in the standby state does not exist, blank is displayed. Meanwhile, when any instruction is input by pressing any one of the operation keys 134 to 137 in the standby state, the display showing the instruction is performed. The sequence or the language of the display shown in the present aspect is only an example and the present invention is not limited to the sequence or the language of the display shown in the present aspect.

As shown in FIG. 14, a predetermined cod signal is output from the control unit 100 by pressing any one of the operation keys 130 to 133 in the standby state (S1) and the control corresponding to the output code signal is performed. That is, when the operation key 130 is pressed in the standby state, the media function can be performed (S2). When the operation key 131 is pressed in the standby state, the copy function can be performed (S3). When the operation key 132 is pressed in the standby state, the facsimile function can be performed (S4). When the operation key 133 is pressed in the standby state, the scan function can be performed (S5). The printer function can be always performed based on the data transmitted from the computer while any one of the media function, the copy function, the facsimile function and the scan function is selected.

The control unit 100 maintains the instructions which can be input by the operation keys 130 to 137 as a layered structure. A first layer comprises selection instructions for selecting the functions and a second layer comprises instructions for various settings in the respective functions. That is, the instructions based on “Media”, “COPY”, “FAX” and“SCAN” displayed in the sub areas 150 to 153 in the standby state configure the first layer. The instructions for inputting the settings of the respective functions in correspondence with the instructions of the first layer configure the second layer.

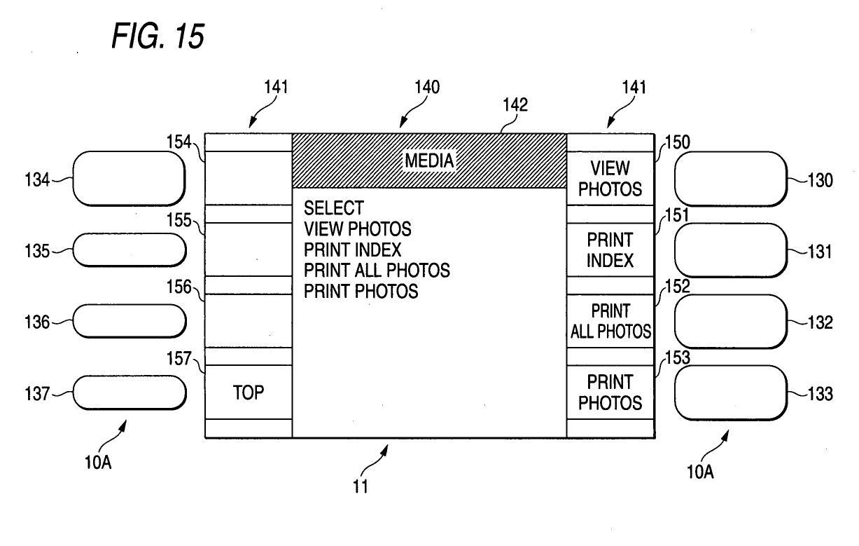

FIG. 15 shows the screen display (second display screen) of the liquid crystal display unit 11 when the operation key 130 corresponding to the display of “Media” is pressed in the standby state. As a result, the media function is performed or various settings are performed. The media function means that image data stored in the small-sized memory card inserted into the slot part 8 is read and printed. In this screen, the content display area 140 is disposed at the central portion of the screen and the key input display area 141 is disposed at the left and right sides of the screen. The key input display area 141 is divided into the sub areas 150 to 157 in correspondence with the operation keys 130 to 137. In the sub area 150 to 157, the instructions of the second layer which can be input by the operation keys 130 to 137 are displayed, respectively.

As shown in FIG. 15, a function display area 142 for displaying the instruction of the first layer is formed at the upper side of the screen of the content display area 140. In the function display area 142, the instruction of the first layer which is input in the first display screen is displayed. In FIG. 15, “Media” representing the media function is displayed. As a result, the user can recognize under which instruction of the first layer the instruction of the second layer is performed in the setting screen (second display screen) of the function, the operability is improved.

As shown in FIG. 15, four functions comprising “ViewPhotos”, “Print Index”, “Print All Photos” and “Print Photos” is displayed in the content display area 140. The “View Photos” represents a function for displaying an image of the image data stored in the small-sized memory card on the liquid crystal display unit 11. The “Print Index” represents a function for index-printing the image of the image data stored in the small-sized memory card. The “Print All Photos” represents a function for printing the image of the entire image data stored in the small-sized memory card. The “Print Photos” represents a function for selectively printing the image of any image data among the image data stored in the small-sized memory card.

As shown in FIG. 15, “View Photos”, “Print Index”, “Print All Photos” and “Print Photos” are displayed in the sub areas 150 to 153, respectively. In the sub area 157, “top” is displayed. The display of “top” represents that, when the operation key 137 is pressed, the display returns to the standby screen shown in FIG. 13. In this screen, when any one of the operation keys 130 to 133 is pressed, a predetermined code signal is output from the control unit 100, the control corresponding to the output code signal is performed, and any one of the above-described functions is performed. When the operation key 137 is pressed, a predetermined code signal is output from the control unit 100, the control corresponding to the output code signal is performed, and the display of the liquid crystal display unit 11 becomes the standby screen. As a result, the user can recognize that the above-described functions are performed by pressing the operation keys 130 to 137. Since the instructions of the first layer and the instructions of the second layer are assigned to the operation keys 130 to 137, the number of the operation keys can become smaller than the number of the instructions.

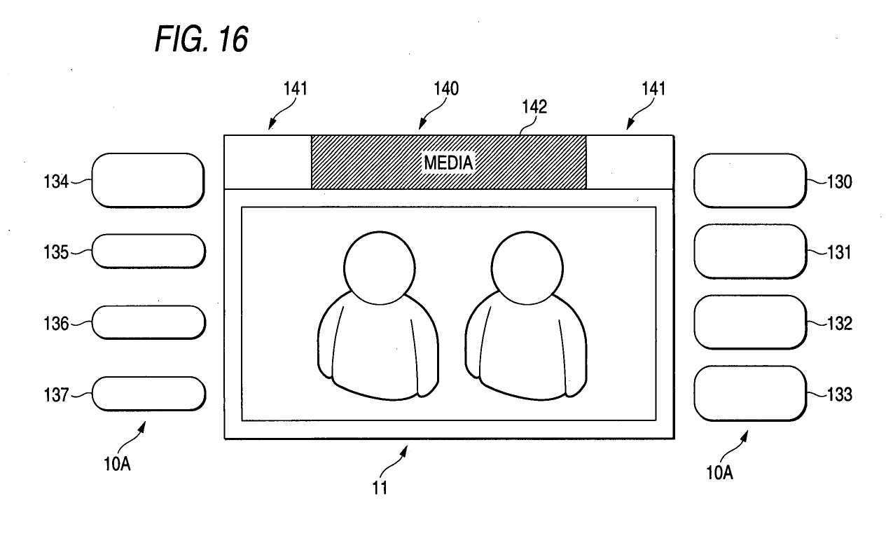

FIG. 16 shows the screen display of the liquid crystal display unit 11 when the operation key 130 corresponding to the display of “View Photos” is pressed in FIG. 15. As a result, the image based on the image data stored in the small-sized memory card can be confirmed through the liquid crystal display unit 11. In the function display area 142 of the liquid crystal display unit 11, “media” representing the media function is displayed. The content display area 140 is horizontally magnified and displayed, without displaying the key input display area 141. In the content display area 140, the image of one piece of image data among the image data stored in the small-sized memory card is displayed. By operating the navigation key comprised in the operation keys 10B, the user can display the image of the other image data in the content display area 140. By pressing the stop key, the image display is finished.

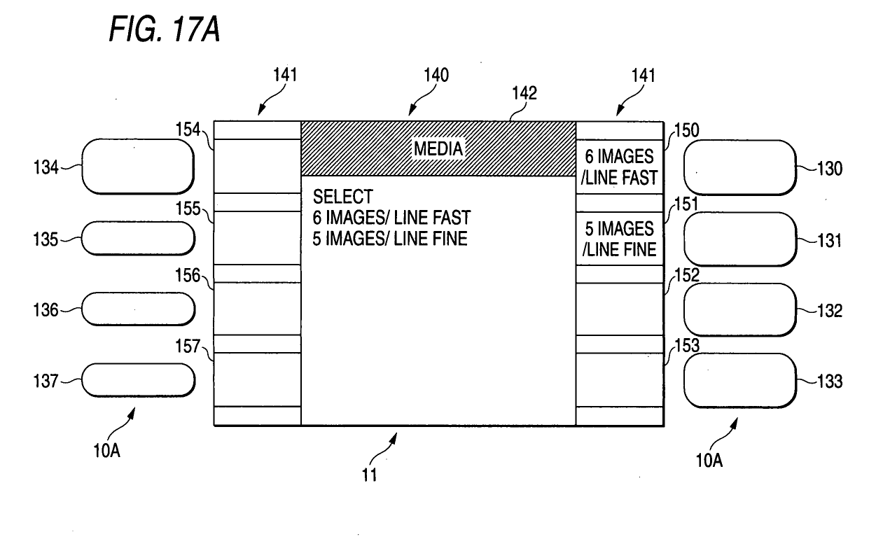

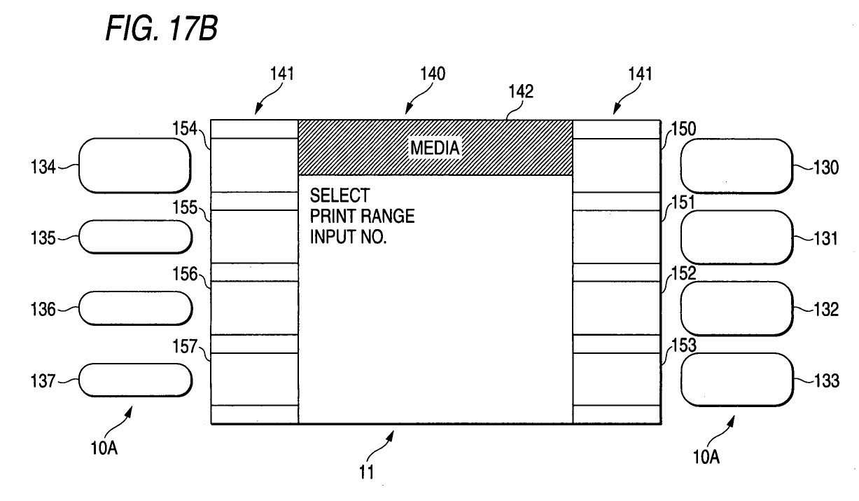

FIG. 17A shows the screen display of the liquid crystal display unit 11 when the operation key 131 corresponding to the display of “Print Index” is pressed in FIG. 15. As a result, the image based on the image data stored in the small-sized memory card can be index-printed. In the function display area 142 of the liquid crystal display unit 11, The “Media ” representing the media function is displayed. In the content display area 140, it is displayed that “6 images/Line fast” and “5 images/Line fine” can be selected. The “6 images/Line fast” represents that six images per one row are printed in the index print. The “5 images/Line fine” represents that five images per one row are printed in the index print. In the case of five images per one row, the print speed is smaller than that of the case of six images per one row, the print quality is excellent.

As shown in FIG. 17A, the “6 images/Line fast” and “5 images/Line fine” are displayed in the sub areas 150 and 151, respectively. In this screen, when any one of the operation keys 130 and 131 is pressed, a predetermined code signal is output from the control unit 100 and the control corresponding to the output code signal is performed. Then, the screen shown in FIG. 17B is displayed. In this screen, the “Media” representing the media function is displayed in the function display area 142 of the liquid crystal display unit 11. In the content display area 140, “Print Range Input No.” is displayed. The range of the image data which is index-printed is input by the dial key comprised in the operation keys 10C. When the start key comprised in the operation keys 10B is pressed, the index print based on this setting is performed by the printer unit 2.

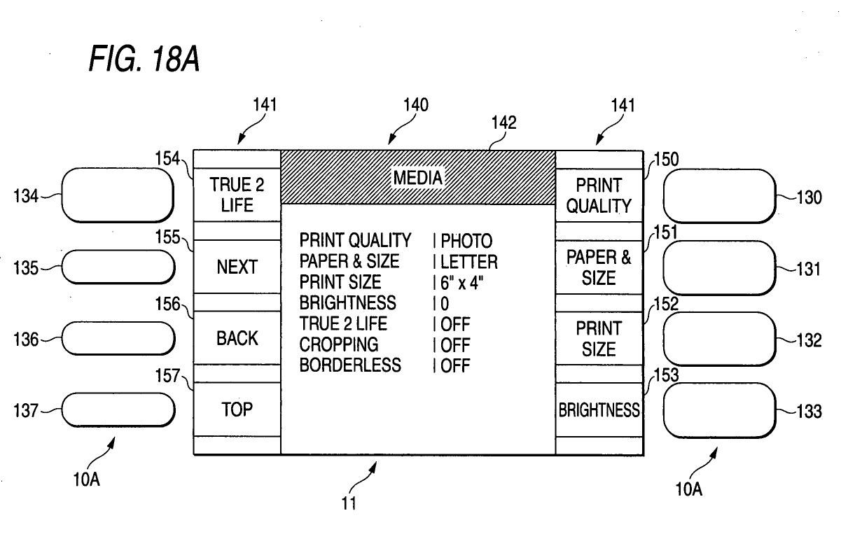

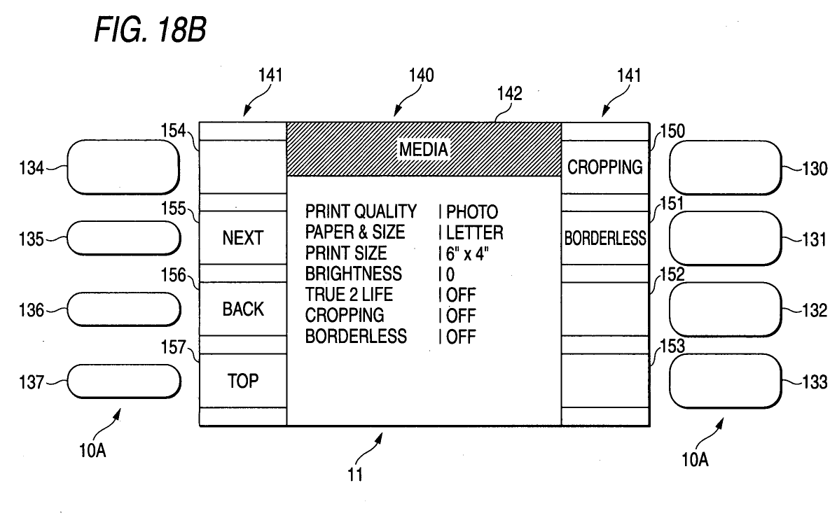

FIG. 18A shows the screen display of the liquid crystal display unit 11 when the operation keys 132 or 133 corresponding to the display of the “Print All Photos” or the “Print Photos” is pressed in FIG. 15. As a result, the image based on the image data stored in the small-sized memory card is printed by the printer 2. In the function display area 142 of the liquid crystal display unit 11, “Media” representing the media function is displayed.

In the content display area 140, various settings which can be input in the “Print All Photos” or the “Print Photos” and current setting state are displayed. More specifically, in the content display area 140, seven settings comprising “Print Quality”, “Paper size”, “PrintSize”, “Brightness”, “True 2 Life”, “Cropping” and “Borderless” are displayed. The “Print Quality” represents print quality. As the print quality, for example, any one of normal and photo can be set. Since the “photo” is displayed in the content display area 140, it can be seen that photo quality is currently set. The “Paper Size” represents the size of the record sheet. As the size of the record sheet, an L type, a 2L type, a postcard, a letter or the A4 size can be set. Since the “Letter” is displayed in the content display area 140, it can be seen that the letter size is currently set. The “Print size” represents the print size. As the print size, for example, 6 inches×4 inches can be set. Since 6″×4″ is displayed in the content display area 140, it can be seen that 6 inches×4 inches is currently set. The “Brightness” represents the brightness of the print image. As the brightness of the print image, for example, total five steps comprising the normal step, two steps located at a positive side of the normal and two steps located at a negative side of the normal can be set. Since “0” is displayed in the content display area 140, it can be seen that the normal step is currently set. The “True 2 Life” represents quality enhancement. As the quality enhancement, for example, white balance, sharpness and color adjustment each having five steps can be set. Since “Off” is displayed in the content display area 140, it can be seen that the quality enhancement is currently not set. The “Cropping” represents image trimming. Since “Off” is displayed in the content display area 140, it can be seen that the trimming is currently not set. The “Borderless” represents borderless print. Since “Off” is displayed in the content image area 140, it can be seen that the borderless print is currently not set.

As shown in FIG. 18A, the “Print Quality”, “Paper Size”, “Print Size”, “Brightness” and “True 2 Life” are displayed in the sub area 150 to 154, respectively. In the sub areas 155 to 157, “next”, “back” and “top” are displayed, respectively. The display of “next” represents that the screen is transferred to a next setting screen shown in FIG. 18B by pressing the operation key 135. The display of “back” represents that the screen returns to a previous screen by pressing the operation key 136. In this screen, when any one of the operation keys 130 to 134 is pressed, a predetermined code signal is output from the control unit 100, the control corresponding to the output code signal is performed, and the above-described setting scan be input. The settings are, for example, selected and determined by the navigation key comprised in the operation keys 10B.

In FIG. 18A, when the operation key 135 is pressed, the screen is transferred to the screen shown in FIG. 18B. In this screen, “Cropping” and “Brightness” are displayed in the sub areas 150 and 151, respectively. In the sub areas 155 to 157, “next”, “back” and “top” are displayed, respectively. In this screen, when any one of the operation keys 130 and 131 is pressed, a predetermined code signal is output from the control unit 100, the control corresponding to the output code signal is performed, and the above-described setting scan be input. The settings are, for example, selected and determined by the navigation key comprised in the operation keys 10B. When the start key comprised in the operation keys 10B is pressed after the various settings are input, the image print based on the settings is performed by the printer unit 2.

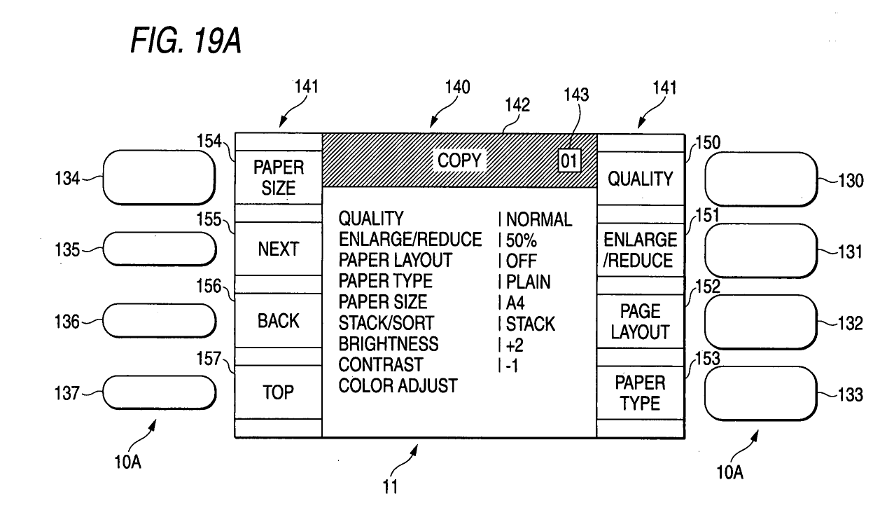

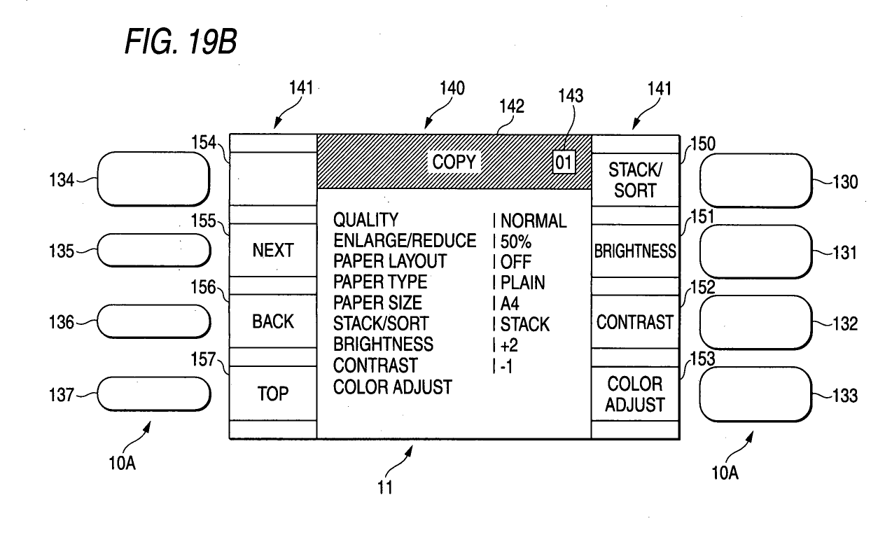

FIG. 19A is the screen display (second display screen) of the liquid crystal display unit 11 when the operation key 131 corresponding to the display of “COPY” is pressed in the standby state. As a result, the copy function is performed or various settings are performed. The copy function is to print the image read by the scanner unit 3 by the printer unit 2. Even in this screen, the content display area 140 is disposed at the central portion of the screen and the key input display area 141 is disposed at the left and right sides of the screen. Similarly, the key input display area 141 is divided into the sub areas 150 to 157 in correspondence with the operation keys 130 to 137. The instructions of the second layer which can be input by the operation keys 130 to 137 are displayed in the sub areas 150 to 157, respectively.

As shown in FIG. 19A, the function display area 142 for displaying the instruction of the first layer is provided at the upper side of the screen of the content display area 140. In the function display area 142, the instruction of the first layer which is input in the first display screen is displayed. In FIG. 19, “COPY” representing the copy function is displayed. As a result, the user can recognize under which instruction of the first layer the instruction of the second layer is performed in the setting screen (second display screen) of the function, the operability is improved.

In the content display area 140, various settings and current setting state which can be input in the copy function are displayed. More specifically, nine settings comprising “Quality”, “Enlarge/Reduce”, “Paper Layout”, “Paper Type”, “Paper size”, “Stack/Sort”, “Brightness”, “Contrast” and “Color Adjust” are displayed in the content display area 140. The “Quality” represents copy quality. As the copy quality, for example, any one of high-speed, normal and high quality is displayed. Since “Normal” is displayed in the content display area 140, it can be seen that the normal is currently set. The “Enlarge/Reduce” represents enlargement copy or reduction copy. As the enlargement copy/reduction copy, for example, setting of 86% for reducing the A4 size to the B5 size can be selected and any enlargement ratio or reduction ratio having a predetermined magnification can be selected. Since 50% is displayed in the content display area 140, it can be seen that 50% reduction copy is currently set. The “Paper Layout” represents layout copy or poster copy. As the layout copy or the poster copy, two or four documents can be layout on one record sheet or the document can be enlarged to a poster size of 3×3 and printed on nine record sheets. Since “Off” is displayed in the content display area 140, it can be seen that the layout copy or the poster copy is currently not set.

The “Paper Type” represents the kind of the record sheet. As the kind of the record sheet, for example, plain paper, inkjet glossy paper and OHP film can be set. Since “Plain” is displayed in the content display area 140, it can be seen that the plain paper is currently set. The “Print Size” represents the copy size. As the copy size, for example, the A4 size, the B5 size and a postcard can be set. Since “A4” is displayed in the content display area 140, it can be seen that the A4 size is currently set. The “Stack/Sort” represents an ejecting method. When a sort function is added to the ejection tray 2l, sort can be selected. Since “Stack” is displayed in the content display area 140, it can be seen that a general ejecting method of ejecting the record sheet on the ejection tray 21 is currently set. The “Brightness” represents the brightness of the copy. As the brightness of the copy, for example, five steps comprising a normal step, two steps located at the positive side of the normal step and two steps located at the negative side of the normal step can be set. Since “+2” is displayed in the content display area 140, it can be seen that a step which is separated from the normal step by two steps toward the positive side is currently set. The “Contrast” represents the contrast of the copy. As the contrast, for example, five steps comprising a normal step, two steps located at the positive side of the normal step and two steps located at the negative side of the normal step can be set. Since “−1” is displayed in the content display area 140, it can be seen that a step which is separated from the normal step by one step toward the negative side is currently set. The “ColorAdjust” represents color setting. As the color setting, for example, total five steps comprising a normal step, two steps located at the positive side of the normal step and two steps located at the negative side of the-normal step can be set with respect to respective colors of red, green and blue.

In the screen (second display screen) shown in FIG. 19A, the “Quality”, “Enlarge/Reduce”, “Paper Layout”, “Paper Type” and “Paper Size” are displayed in the sub areas 150 to 154, respectively. In the sub areas 155 to 157, the “next”, “back” and “top” are displayed, respectively. In the screen shown in FIG. 19B (third display screen), the “Stack/Sort”, “Brightness”, “Contrast” and “Color Adjust” are displayed in the sub areas 150 to 153, respectively. In the subareas 155 to 157, the “next”, “back” and “top” are displayed, respectively.

The instructions of the second layer in the copy function correspond to nine settings, of which the number is larger than the number (eight) of the operation keys 130 to 137. Accordingly, the control unit 100 allows some of the instructions to be displayed in the sub areas 150 to 154 of the screen shown in FIG. 19A, allows those instructions to be assigned to the respective operation keys 130 to 134, allows the rest of the instructions to be displayed in the sub areas 150 to 153 of the screen shown in FIG. 19B, and allows those instructions to be assigned to the respective operation keys 130 to 133. The instructions “next” and “back” for switching the display of the screen are displayed in the sub areas 155 and 156 of the screens and those instructions are assigned to the operation keys 135 and 136, respectively. As a result, since a plurality of instructions of the same layer can be assigned to one operation key, the number of the operation keys can become smaller than that of the instructions of the same layer.

In these screens, when any one of the operation keys 130 to 134 is pressed, a predetermined code signal is output from the control unit 100, the control corresponding to the output code signal is performed, and, as a result, the above-described settings can be input. The settings are, for example, selected and determined by the navigation key comprised in the operation keys 10B. After the various settings are input, the input of the number of copies is performed by the dial key comprised in the operation keys 10C. The number of copies is displayed in a copy number display area 143 formed in the function display area 142. When the start key comprised in the operation keys 10B is pressed, the copy based on the settings is performed by the printer unit 2 and the scanner unit 3.

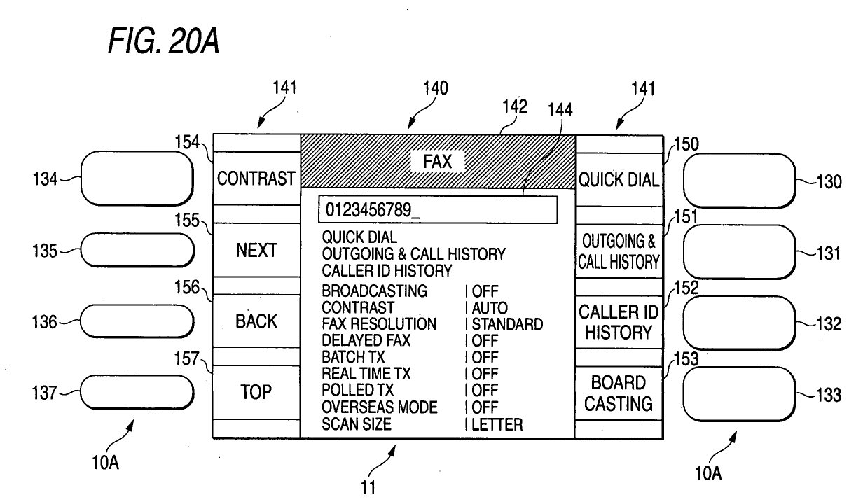

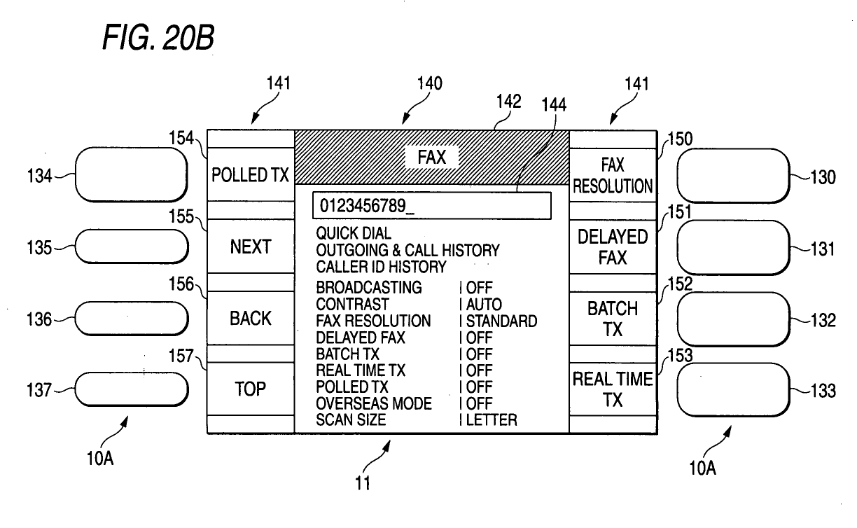

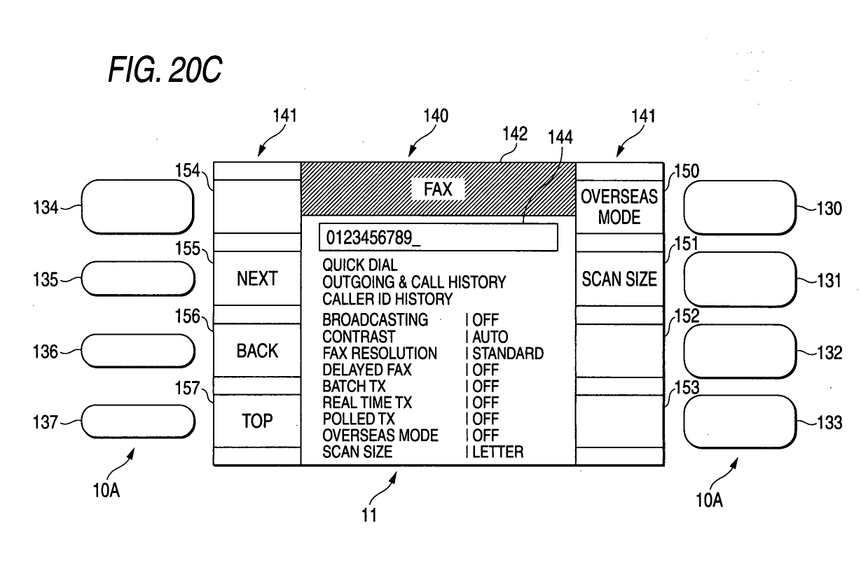

FIG. 20A shows the screen display (second display screen) of the liquid crystal display unit 11 when the operation key 132 corresponding to the display of “FAX” is pressed in the stand by state. As a result, the facsimile function is performed or various settings are performed. The facsimile function is to transmit an image read by the scanner unit 3 through a telephone line as facsimile data or to print facsimile data received through the telephone line using the printer unit 2. Even in this screen, the content display area 140 is disposed at the central portion of the screen and the key input display area 141 is disposed at the left and right sides of the screen. Similarly, the key input display area 141 is divided into the sub areas 150 to 157 in correspondence with the operation keys 130 to 137. The instructions of the second layer which can be input by the operation keys 130 to 137 are displayed in the sub areas 150 to 157, respectively.

As shown in FIG. 20A, the function display area 142 for displaying the instruction of the first layer is provided at the upper side of the screen of the content display area 140. In the function display area 142, the instruction of the first layer which is input in the first display screen is displayed. In FIG. 20, “FAX” representing the facsimile function is displayed. As a result, the user can recognize under which instruction of the first layer the instruction of the second layer is performed in the setting screen (second display screen) of the function, the operability is improved.

In the content display area 140, various settings and current setting state which can be input in the facsimile function are displayed. More specifically, twelve settings comprising “Quick Dial”, “Outgoing & Call history”, “Caller ID history”, “Broadcasting”, “Contrast”, “Fax Resolution”, “Delayed Fax”, “Batch TX”, “Real Time TX”, “Polled TX”, “Overseas Mode” and “Scan Size” are displayed in the content display area 140. The “Quick Dial” represents the speed dial. The speed dial may be previously registered in a telephone directory. The “Outgoing & Call history” and “Caller ID history” represent communication management. As the communication management, print of a latest transmission/reception report or a transmission report can be set. The “Broadcasting” represents manual transmission. The manual transmission can be turned on/off. Since “Off” is displayed in the content display area 140, it can be seen that the manual transmission is currently not set. The “Contrast” represents the contrast of the document. As the contrast of the document, for example, “auto”, “lighter” and “darker” can be set. Since “Auto” is displayed in the content display area 140, it can be seen that the auto is currently set. The “Fax Resolution” represents the quality of the document. As the quality of the document, for example, “Standard”, “Fine” which is set when the character of the document is small, “Super Fine” which is set when the character of the document is smaller and “Photo” which is set when photo is contained in the document can be. set. Since “Standard” is displayed in the content display area 140, it can be seen that the standard is currently set.

The “Delayed Fax” represents timer transmission. In the timer transmission, for example, the facsimile function may be performed at a specific transmission time. Since “Off” is displayed in the content display area 140, it can be seen that the timer transmission is currently not set. The “Batch Fax” represents batch transmission. In the batch transmission, for example, when a plurality of timer transmissions is set with respect to a same counterpart at a same transmission time, one transmission can be set to be performed. Since “Off” is displayed in the content display area 140, it can be seen that the batch transmission is currently not set. The “RealTimeTX” represents real time transmission. In the real time transmission, the image of the document can be immediatelyread and transmitted by dialing the telephone number of a counterpart. Since “Off” is displayed in the content display area 140, it can be seen that the real time transmission is currently not set. The “Polled Tx” represents polled transmission. In the polled transmission, the document can be automatically transmitted by operating the facsimile machine of a counterpart. Since “Off” is displayed in the content display area 140, it can be seen that the polled transmission is currently not set. The “Overseas Mode” represents overseas transmission. In the overseas transmission, communication error can be reduced when overseas facsimile transmission is performed. Since “Off” is displayed in the content display area 140, it can be seen that the overseas transmission is currently not set. The “Scan Size” represents the size of the document. As the size of the document, for example, the A4 size, the B5 size and the letter size can be set. Since “Letter” is displayed in the content display area 140, it can be seen that the letter size is currently set.

In the screen (second display screen) shown in FIG. 20A, the “Quick Dial”, “Outgoing & Call history”, “Caller ID history”, “Broadcasting” and “Contrast” are displayed in the sub areas 150 to 154, respectively. In the sub areas 155 to 157, the “next”, “back” and “top” are displayed, respectively. In the screen shown in FIG. 20B (third display screen), the “Fax Resolution”, “Delayed Fax”, “Batch TX”, “Real Time TX” and “Polled TX” are displayed in the sub areas 150 to 154, respectively. In the sub areas 155 to 157, the “next”, “back” and “top” are displayed, respectively. In the screen shown in FIG. 20C (third display screen), the “Overseas Mode” and “Scan Size” are displayed in the sub areas 150 and 151, respectively. In the sub areas 155 to 157, the “next”, “back” and “top” are displayed, respectively.

The instructions of the second layer in the copy function correspond to twelve settings, of which the number is larger than the number (eight) of the operation keys 130 to 137. Accordingly, the control unit 100 allows some of the instructions to be displayed in the sub areas 150 to 154 of the screen shown in FIG. 20A, allows those instructions to be assigned to the respective operation keys 130 to 134, allows the rest of the instructions to be displayed in the sub areas 150 to 154 of the screen shown in FIGS. 20B and 20C, and allows those instructions to be assigned to the respective operation keys 130 to 134. The instructions “next” and “back” for switching the display of the screen are displayed in the sub areas 155 and 156 of the three screens and those instructions are assigned to the operation keys 135 and 136, respectively. As a result, since a plurality of instructions of the same layer can be assigned to one operation key, the number of the operation keys can become smaller than that of the instructions of the same layer.

In these screens, when any one of the operation keys 130 to 134 is pressed, a predetermined code signal is output from the control unit 100, the control corresponding to the output code signal is performed, and, as a result, the above-described settings can be input. The settings are, for example, selected and determined by the navigation key comprised in the operation keys 10B. The facsimile number is input by the dial key comprised in the operation keys 10C. The facsimile number is displayed in a facsimile number display area 144 formed in the content display area 140. When the start key comprised in the operation keys 10B is pressed, the facsimile transmission based on the settings is performed by the printer unit 2 and the scanner unit 3.

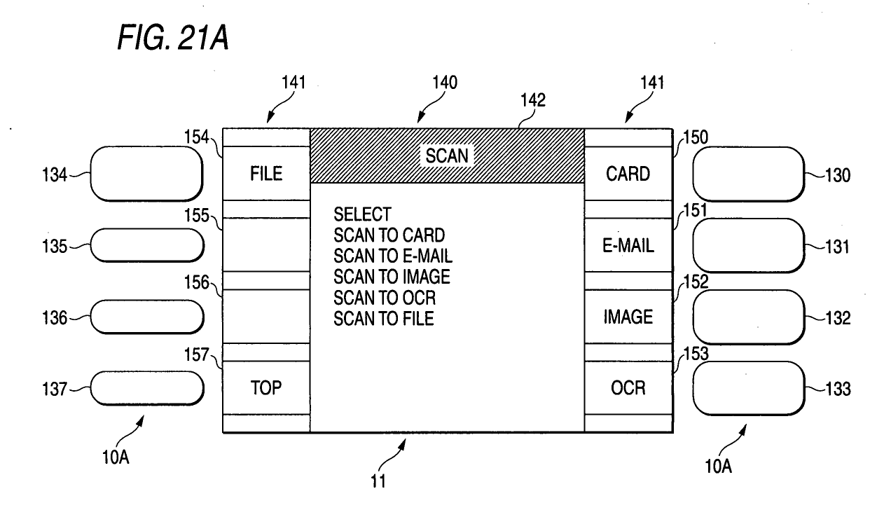

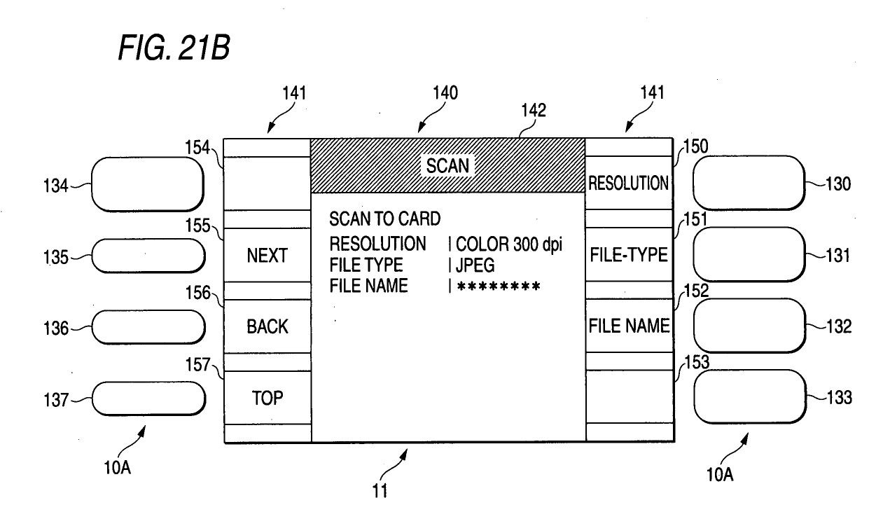

FIG. 21A shows the screen display (second display screen) of the liquid crystal display unit 11 when the operation key 133 corresponding to the display of “SCAN” is pressed in the standby state. As a result, the scan function is performed or various settings are performed. The scan function is to read the image of a document by the scanner unit 3 and store image data of the read image in a small-sized memory card inserted into the slot part 8. Even in this screen, the content display area 140 is disposed at the central portion of the screen and the key input display area 141 is disposed at the left and right sides of the screen. Similarly, the key input display area 141 is divided into the sub areas 150 to 157 in correspondence with the operation keys 130 to 137. The instructions of the second layer which can be input by the operation keys 130 to 137 are displayed in the sub areas 150 to 157, respectively.

As shown in FIG. 21A, the function display area 142 for displaying the instruction of the first layer is provided at the upper side of the screen of the content display area 140. In the function display area 142, the instruction of the first layer which is input in the first display screen is displayed. In FIG. 21A, “SCAN” representing the scan function is displayed. As a result, the user can recognize-under which instruction of the first layer the instruction of the second layer is performed in the setting screen (second display screen) of the function, the operability is improved.

As shown in FIG. 21A, five functions comprising “Card”, “E-mail”, “Image”, “OCR” and “File” are displayed in the content display area 140. The “Card” represents a function for storing the image data read by the scanner unit 3 in the small-sized memory card. The “E-mail” represents a function for using the image data read by the scanner unit 3 as an attached file. The “Image” represents a function for displaying the image read by the scanner unit 3 on the computer connected to the multi function device 1. The “OCR” represents a function for converting characters contained in the image data read by the scanner unit 3 into text data. The “File” represents a function for storing the image data read by the scanner unit 3 in any storage medium.

As shown in FIG. 21A, the “Card”, “E-mail”, “Image” and “File” are displayed in the sub areas 150 to 154, respectively. In the sub area 157, “top” is displayed. In this screen, when any one of the operation keys 130 to 134 is pressed, a predetermined code signal is output from the control unit 100, the control corresponding to the output code signal is performed, and, as a result, the above-described functions can be performed. When any the operation key 137 is pressed, a predetermined code signal is output from the control unit 100, the control corresponding to the output code signal is performed, and, as a result, the display of the liquid crystal display unit 11 becomes the screen of the standby state.

FIG. 21B shows the screen display (second display screen) of the liquid crystal display unit 11 when the operation key 130 corresponding to the display of “Card” is pressed in FIG. 21A. As a result, the image data read by the scanner unit 3 is stored in the small-sized memory card inserted into the slot part 8. The “SCAN” which represents the scan function is displayed in the function display area 142 of the liquid crystal display unit 11.

In the content display area 140, various settings and current setting state which can be input in the “Card” are displayed. More specifically, settings comprising “Resolution”, “File Type” and “File Name” are displayed in the content display area 140. The “Resolution” represents scan quality. As the scan quality, for example, color 150 dpi, color 300 dpi, color 600 dpi, monochrome 200×100 dpi and monochrome 200 dpi can be set. Since “Color 300 dpi” is displayed in the content display area 140, it can be seen that color 300 dpi is currently set. The “File Type” represents the format of a file for storing the image data. As the file format, for example, a PDF format, a JPEG format and a TIFF format can be set. Since “JPEG” is displayed in the content display area 140, it can be seen that the JPEG format is currently set. The “File Name” represents a file name. The file name represents the name of the stored file and may be given with any name.

In this screen, when any one of the operation keys 130 to 132 is pressed, a predetermined code signal is output from the control unit 100, the control corresponding to the output code signal is performed, and, as a result, the above-described settings can be input. The settings are, for example, selected, input and determined by the navigation key comprised in the operation keys 10B or the dial key comprised in the operation keys 10C. When the start key comprised in the operation keys 10C is pressed, the scan based on the settings is performed by the scanner unit 3 and the slot part 8.

Since the instructions which can be input by the operation keys 130 to 137 disposed in the vicinity of the liquid crystal display unit 11 are displayed in the key input display area 141 of the liquid crystal display unit 11, the user can recognize the instruction input by the operation keys 130 to 137 through the display of the key input display area 141 and the operability of the device is improved. By assigning the plurality of instructions to one operation key, the number of the operation keys becomes smaller than that of the instructions and, as a result, the space of the operation keys 130 to 137 and the liquid crystal display unit 11 can be reduced.

The operation keys 130 to 137 may have different colors such as green, orange, red and so on and the sub areas 150 to 157 of the key input display area 141 of the liquid crystal display unit 11 may be displayed with the same colors as the operation keys 130 to 137, respectively. As a result, since the user can recognize the sub areas 150 to 157 in which the instructions input by the operation keys 130 to 137 are displayed with respective colors in addition to the positional relationship between the operation keys 130 to 137 and the sub areas 150 to 157, the operability is improved.

The operation keys 130 to 137 may be lighted up by forming the operation keys 130 to 137 using a transmissive material and disposing LEDs in the operation keys 130 to 137. The control unit 100 may allow the operation keys 130 to 137 corresponding to the sub area 150 to 157 for displaying instructions which can be input to be lighted up. That is, as shown in FIG. 13, when instructions are not assigned to the operation keys 134 to 137 in the standby state, the operation keys 134 to 137 are turned off and only the operation keys 130 to 133 are lighted up. As a result, since the user can judge the operation keys 130 to 13 which can be input by the lighting in addition to the display of the sub area 150 to 157, the operability is improved.

Although the multi function device 1 has four functions comprising the media function, the copy function, the facsimile function and the scan function in the present aspect, the present invention may be applied to a device have at least two functions of the four functions andtheprinter function and all the functions are not necessarily needed.

According to the multi function device 1, since the instruction which can be input by the operation keys 130 to 137 disposed in the vicinity of the liquid crystal display unit 11 are displayed in the key input display area 141 of the liquid crystal display unit 1, the user can recognize the instruction input by the operation keys 130 to 137 through the display of the key input display area 141. Particularly, since the instructions are displayed in the sub areas 1S0 to 157 of the key input display area 141 close to the operation keys 130 to 137, the user can view the liquid crystal display unit 11 and easily understand the instructions which can be input by the operation keys 130 to 137. Accordingly, the operability of the device is improved.

Since the instructions are layered and the instruction which can be input by the operation keys 130 to 137 are displayed in the sub area 150 to 157 in the screen of the standby state (first display screen) and the setting input screen (second display screen) of the liquid crystal display unit and the plurality of instructions are assigned to one of the operation keys 130 to 137, the number of the operation keys can become smaller than that of the instructions and, as a result, the space of the operation keys 130 to 137 and the liquid crystal display unit 11 can be reduced.

As was described, the operation key may be disposed in plural in the vicinity of the display unit, and the control unit may allow the key input display area to be divided into a plurality of sub areas which are close to the respective operation keys, allow the instructions which can be input by the operation keys which are close to the respective sub areas to be displayed, and allow the code signals corresponding to the instructions which are displayed close to the operation keys to be output based on the inputs of the respective operation keys.

The operation key is disposed in plural in the vicinity of the display unit. The key input display area of the display unit is divided into the plurality of sub areas in correspondence with the operation keys. The instruction which can be input by the closest operation key is displayed in each of the-sub areas. Accordingly, the user can recognize which instruction is selected by pressing any one of the plurality of operation keys, by the display of the sub areas.

Also, the operation keys may be vertically arranged on the side of the display unit in a row, and the display unit may have the key input display area at the side which is close to the operation keys.

For example, when the display unit is rectangular and extends horizontally, the both sides of the display unit are used as the key input display area and, as a result, the content display area and the key input display area are easily viewed. Since the operation keys and the display unit extend horizontally, space efficiency is excellent when the operation keys and the display unit are displayed at the front side of the multi function device.

Further, the control unit may hold the instructions which can be input by the operation keys in a layered structure, allow a first display screen, which displays an instruction of a first layer that can be input by a predetermined operation key in the sub area corresponding to the operation key, to be displayed on the display unit, and allow a second display screen, which displays an instruction of a second layer that can be input by a predetermined operation key in the sub area corresponding to the operation key, to be displayed on the display unit, according to the input of the instruction of the first layer in the first display screen.

In the first display screen, the instruction of the first layer is displayed in the sub area corresponding to the operation key. When the operation key corresponding to the instruction of the first layer having the second layer is input, the second display screen is displayed in the display unit. In the second display screen, the instruction of the second layer is displayed in the sub area corresponding to the operation key. Accordingly, since the instruction of the first layer and the instruction of the second layer are assigned to one operation key, the number of the operation keys becomes smaller than that of the instructions.

Further, the control unit may allow the instruction of the first layer, which is input in the first display screen, to be displayed in an area other than the sub area of the second display screen.

Accordingly, since the user can recognize under which first layer the instruction of the second layer is performed in the second display screen, operability is improved.

Also, the instruction of the first layer may be a selection instruction for selecting the functions and the instruction of the second layer may be an instruction for various settings in the respective functions.

Further, the second layer may comprise a plurality of instructions the number of which is larger than that of the operation keys. The control unit may allow a predetermined sub area to display an instruction for displaying a third display screen on the second display screen while allowing the other of sub areas to display some of the instructions of the second layer. When the instruction for displaying the third display screen is input, the control unit may allow a predetermined sub area to display an instruction for displaying the second display screen on the third display screen while allowing the other of sub areas to display the rest of the instructions of the second layer.

In the second display screen, some of the instructions of the second layer are displayed in the sub areas. The instruction for displaying the third display screen is also displayed in the sub area. By inputting the operation key corresponding to this instruction, the third display screen is displayed on the display unit. In the third display screen, the rest of the instructions of the second layer are displayed. The instruction for displaying the second display screen is also displayed in the sub area. Accordingly, since the plurality of instructions of the same layer is assigned to one operation key, the number of the operation keys becomes smaller than that of the number of the instructions of the same layer.

Further, the operation keys may have different colors, respectively, and the control unit may allow the sub areas which are close to the respective operation keys to be displayed with the same colors as the operation keys, respectively.

Accordingly, since the user can recognize the sub areas in which the instructions in put by the operation keys are displayed by the color, in addition to the positional relationship between the operation keys and the subareas, the operability is improved.

Also, the operation keys can be lighted up, and the control unit may allow only operation keys corresponding to the sub areas for displaying the instructions which can be input to be lighted up.

The control unit lights up only the operation keys corresponding to the sub areas for displaying the instructions which can be input. That is, the operation key corresponding to the sub area in which the instruction is not displayed is turned off. Accordingly, since the user can judge the operation key which can be input by the light in addition to the display of the sub area, the operability is improved.

Furthermore, the functions may comprise at least two of a printer function, a copy function, a facsimile function and a scan function.

What is claimed is:

1. A multi function device having a plurality of functions, comprising:
an operation key that inputs an instruction for the function;
a display unit that displays information on the function; and
a control unit that outputs a predetermined code signal based on an input of the operation key and controls display contents of the display unit,
wherein the operation key is disposed in a vicinity of the display unit,
the display unit comprises a content display area that displays a setting for the function and a key input display area that displays the instruction to be input by the operation key, and
the control unit allows the instruction to be input by the operation key to be displayed in the key input display area and allows the code signal corresponding to the instruction displayed based on the input of the operation key to be output.

2. The multi function device according to claim 1, wherein the operation key comprises a plurality of operation keys that are disposed in the vicinity of the display unit, and
the control unit allows the key input display area to be divided into a plurality of sub areas that are close to the respective operation keys, allows the instructions to be input by the operation keys to be displayed, and allows the code signals corresponding to the instructions displayed close to the operation keys to be output based on the inputs of the respective operation keys.

3. The multi function device according to claim 2, wherein the operation keys are arranged on a side of the display unit in a row, and
the display unit has the key input display area at the side.

4. The multi function device according to claim 2, wherein the control unit holds the instructions to be input by the operation keys in a layered structure, allows a first display screen, which displays an instruction of a first layer to be input by a predetermined operation key in the sub area corresponding to the operation key, to be displayed on the display unit, and allows a second display screen, which displays an instruction of a second layer to be input by a predetermined operation key in the sub area corresponding to the operation key, to be displayed on the display unit, according to the input of the instruction of the first layer in the first display screen.

5. The multi function device according to claim 4, wherein the control unit allows the instruction of the first layer, which is input in the first display screen, to be displayed in an area other than the sub area of the second display screen.

6. The multi function device according to claim 4, wherein the instruction of the first layer comprises a selection instruction for selecting the function and the instruction of the second layer comprises instructions for various settings in the respective functions.

7. The multi function device according to claim 4, wherein the second layer comprises a plurality of instructions the number of which is larger than that of the operation keys,
the control unit allows a predetermined sub area to display an instruction for displaying a third display screen on the second display screen while allowing the other of sub areas to display some of the instructions of the second layer, and
when the instruction for displaying the third display screen is input, the control unit allows a predetermined sub area to display an instruction for displaying the second display screen on the third display screen while allowing the other of sub areas to display the rest of the instructions of the second layer.

8. The multi function device according to claim 2, wherein the operation keys have different colors, respectively, and the control unit allows the sub areas, which are close to the respective operation keys, to be displayed with the same colors as the operation keys, respectively.

9. The multi function device according to claim 2, wherein the operation keys are capable of being lighted up, and the control unit allows only the operation keys, which corresponds to the sub areas for displaying the instructions that can be input, to be lighted up.

10. The multi function device according to claim 1, wherein the functions comprise at least two of a printer function, a copy function, a facsimile function and a scan function.
